(19) United States
(12) Patent Application Publication
(10) Pub. No.: US 2015/0027039 A1
(43) Pub. Date: Jan. 29, 2015

(54) APPARATUS AND METHOD FOR DRYING BIOMASS

(71) Applicants: Scott Laskowski, Madisonville, KY (US); Timothy Baughman, Madisonville, KY (US); Johann Duerichen, Smithers, CA (US); Donald Laskowski, Indianapolis, IN (US)

(72) Inventors: Scott Laskowski, Madisonville, KY (US); Timothy Baughman, Madisonville, KY (US); Johann Duerichen, Smithers, CA (US); Donald Laskowski, Indianapolis, IN (US)

(21) Appl. No.: 14/087,090

(22) Filed: Nov. 22, 2013

Related U.S. Application Data
(60) Provisional application No. 61/858,957, filed on Jul. 26, 2013.

(51) Int. Cl. F26B 3/02; C10L 9/08; C10L 9/10; F26B 25/00; C10L 5/40

(52) U.S. Cl. CPC F26B 3/02; F26B 25/003; C10L 5/40; C10L 9/10; C10L 9/08; C10L 2290/08; C10L 2230/14
USPC 44/603; 34/182; 34/500; 44/605; 44/606

(57) ABSTRACT

The present invention relates to an apparatus and method for drying a biomass or organic material through one or more auger tubes that may be connected in series. Rotation of the augers drives the movement of the material longitudinally through the auger tubes. In addition, the one or more auger tubes are also heated by a hot liquid or water that may be circulated through a jacket(s) surrounding the one or more auger tubes, and a generally longitudinal flow of air or gas through the one or more auger tubes may be caused by operation of a fan or blower. The operation of a dryer apparatus of the present invention may also be monitored and controlled by a computer to optimize or improve drying conditions. Thus, one or more operational parameters of a dryer apparatus may be altered or controlled based on one or more measurements, such as temperature.

### CROSS-REFERENCE TO RELATED APPLICATIONS

This application claims the benefit of priority to U.S. Provisional Patent Application No. 61/858,957, filed on Jul. 26, 2013, the entire contents and disclosure of which are incorporated herein by reference.

### BACKGROUND

1. Field of the Invention

The present invention relates to apparatuses and methods for drying biomass material, such as for use in biomass fuel burners or other purposes.

2. Related Art

Many processes utilize biomass material as a source for energy or to acquire useful chemical substances, compounds, etc. Various types of biomass may be used, for example, as a fuel that may be combusted in a burner or engine to generate power or energy. The energy generated by these processes may be used for other purposes, such as to generate heat, make electricity or create mechanical forces. To combust a biomass fuel material, it is generally beneficial for it to be dry so that it can be burned more efficiently.

Biomass and other organic materials may also be utilized in various chemical processes, such as to extract, purify or isolate substances or compounds from them, or to break down, digest, etc., the biomass or organic material to make substances or compounds present within them more accessible or usable. Biomass or organic materials (including compounds, extracts or substances derived from those materials) may also be reacted with other compounds, substances, etc., to synthesize new chemical products. For these purposes, it may be beneficial or necessary for the biomass or organic material to be dried and/or to have any liquid component within it reduced or removed so that the biomass or organic material may be more effectively or efficiently used in a subsequent process and/or more stably or efficiently stored or shipped. Dried biomass may also provide for improved absorption of liquids during use. For example, biomass materials are often used as animal bedding, and one of the main purposes of animal bedding is to absorb or hold animal waste to facilitate its removal.

Thus, there is a need in the art for improved apparatuses and methods for drying biomass or organic material to remove water or other liquids or solvents that may be present that are also more efficient and/or able to utilize different sources of energy. There is also a need in the art for an improved dry biomass or organic material that is more hygroscopic and/or flammable for its efficient burning and removal, as well as methods for making improved biomaterials, etc., having these improved properties.

### SUMMARY

According to a first broad aspect of the present invention, an apparatus is provided for drying a material comprising: an auger tube, the auger tube having an elongated jacket that surrounds most or all of the auger tube and encloses a jacketed space between the jacket and the auger tube; an auger, the auger being positioned within the interior of the auger tube; an auger motor, the auger motor being physically coupled to the auger for causing rotation of the auger; and a blower, the blower being in fluid communication with the interior of the auger tube for causing a flow of air or gas through the auger tube by operation of the blower, wherein the auger tube has a first end and a second end, the first end and the second end of the auger tube being on opposite longitudinal ends of the auger tube, and wherein the auger tube has an input opening for receiving the material into the interior of the auger tube and an output opening for allowing the material to exit the interior of the auger tube, the input opening being at or near the first end of the auger tube and the output opening being at or near the second end of the auger tube.

According to a second broad aspect of the present invention, an apparatus for drying a material is provided comprising two or more auger tubes. Such an apparatus may comprise: two or more auger tubes comprising a first auger tube and a second auger tube; two or more augers comprising a first auger and a second auger, the first auger being positioned within the interior of the first auger tube and the second auger being positioned within the interior of the second auger tube; at least one auger motor, the at least one auger motor comprising a first auger motor physically coupled to one or both of the first and second augers for causing rotation of one or both of the first and second augers; and a blower, the blower being in fluid communication with the interiors of the two or more auger tubes for causing a flow of air or gas through the two or more auger tubes, wherein a first jacket surrounds most or all of the first auger tube and encloses a first jacketed space between the first jacket and the first auger tube, and wherein a second jacket surrounds most or all of the second auger tube and encloses a second jacketed space between the second jacket and the second auger tube, and wherein each of the two or more auger tubes has a first end and a second end, the first end and the second end of each auger tube being on opposite longitudinal ends of the auger tube, wherein each of the two or more auger tubes has an input opening for receiving the material into the interior of the auger tube and an output opening for allowing the material to exit the interior of the auger tube, the input opening being at or near a first end of the respective auger tube and the output opening being at or near a second end of the respective auger tube, and wherein the first and second auger tubes are arranged in series such that the material exiting the output opening of the first auger tube is received into the second auger tube through the input opening of the second auger tube.

According to a third broad aspect of the present invention, methods are provided for drying a material using a drying apparatus of the present invention. Such a method may comprise the following steps: (a) introducing the material into an auger tube at via an input opening, the auger tube having a first end and a second end, the first end and the second end being at opposite ends of the auger tube along the longitudinal axis of the auger tube, wherein the input opening is at or near the first end of the auger tube; (b) moving the material longitudinally through the interior of the auger tube toward the second end of the auger tube by rotation of an auger present inside the interior of the auger tube, the rotation of the auger being driven by an auger motor physically coupled to the auger; (c) heating the auger tube by a liquid or water having an elevated temperature present within a jacketed space enclosed by a jacket surrounding most or all of the auger tube; and (d) causing air or gas to flow longitudinally through the interior of the auger tube by a blower in fluid communication with the interior of the auger tube.

According to embodiments of the present invention, a method for drying a material may comprise the following steps: (a) introducing the material into a first auger tube in a series of two or more auger tubes of a dryer apparatus via a first input opening, the first auger tube having a first end and a second end, the first end and the second end being at opposite ends of the first auger tube along the longitudinal axis of the first auger tube, wherein the input opening being at or near the first end of the first auger tube; (b) moving the material longitudinally through the interior of the first auger tube by rotation of a first auger present within the interior of the first auger tube, the rotation of the first auger being driven by a first auger motor physically coupled to the first auger; (c) introducing the material into a second auger tube in the series of two or more auger tubes of the dryer apparatus via a first output opening of the first auger tube and a second input opening of the second auger tube, the second auger tube having a first end and a second end, the first end and the second end being at opposite ends of the second auger tube along the longitudinal axis of the second auger tube, wherein the first output opening is at or near the second end of the first auger tube, and the second input opening is at or near the first end of the second auger tube; (d) moving the material longitudinally through the interior of the second auger tube by rotation of a second auger present within the interior of the second auger tube, the rotation of the second auger being driven by a second auger motor physically coupled to the second auger; (e) heating the first and second auger tubes by a liquid or water having a first elevated temperature inside a first jacketed space enclosed by a first jacket surrounding most or all of the first auger tube and by the liquid or water having a second elevated temperature inside a second jacketed space enclosed by a second jacket surrounding most or all of the second auger tube; and (f) causing air or gas to flow through the interior of each of the first and second auger tubes by a blower in fluid communication with the interior of the first and second auger tubes.

According to another broad aspect of the present invention, compositions are provided comprising a material dried by a dryer apparatus or method of the present invention with or without an additive and/or other material(s). Such a composition may comprise a material produced by the following steps: (a) adding one or more additives to the material; (b) moving the material longitudinally through each of the one or more auger tubes of a dryer apparatus by rotation of a respective auger inside the auger tube, the rotation of the respective auger being driven by a respective auger motor physically coupled to the auger; (c) heating the one or more auger tubes by a liquid or water having an elevated temperature when inputted into a jacketed space enclosed by a jacket surrounding one of the auger tubes; and (d) causing air or gas to flow through the interior of each of the one or more auger tubes by a blower in fluid communication with the interior of each of the auger tubes.

These and other aspects of the present invention will become apparent to those skilled in the art after reading the following description and claims with the accompanying drawings.

### BRIEF DESCRIPTION OF THE DRAWINGS

The accompanying drawings, which are incorporated herein and constitute part of this specification, illustrate exemplary embodiments of the invention, and, together with the detailed description herein, serve to explain features of the present invention.

FIG. 1 is a perspective view of an embodiment of a dryer apparatus of the present invention with an auger stack and hammer mill enclosed by paneling;

FIG. 2 is a top view of a dryer apparatus and burner unit according to an embodiment of the present invention that are arranged for use together;

FIG. 3 is a perspective view of an embodiment of a dryer apparatus of the present invention with paneling around a distal portion of the auger stack and the hammer mill removed;

FIG. 4 is a lengthwise cross-sectional view of a dryer apparatus according to an embodiment of the present invention;

FIG. 5 is a perspective view of a proximal portion of a dryer apparatus according to an embodiment of the present invention;

FIG. 6A is a lengthwise cross-sectional view of a distal portion of a dryer apparatus according to an embodiment of the present invention;

FIG. 6B is a perspective view of a distal portion of a dryer apparatus according to an embodiment of the present invention; and

FIGS. 7-10 each show a flow diagram, algorithm and/or method for the operation of a dryer apparatus according to embodiments of the present invention.

### DETAILED DESCRIPTION

The present invention relates to a novel and improved device, apparatus and method for drying a solid biomass or organic material and/or for removing, reducing, lessening, etc., the amount, content, volume, weight, etc., of moisture, solvent(s), liquid(s), etc., such as water, that may be present in a solid biomass or organic material. In addition to drying, the device, apparatus and method of the present invention may also be used for combining, blending, etc., a solid biomass or organic material with one or more other substances or additives, which may affect the properties of the biomass or organic material, and/or possibly other biomass material(s) and/or organic material(s).

For purposes of the present invention, the terms “biomass,” “biomass material,” or “biomaterial” refer interchangeably to any substance(s) or material(s) originating or obtained directly or indirectly from a living organism, or a product obtained, produced, or made by or from a living organism(s), that has at least a solid or particulate component. Examples of such “biomass” may include animal or plant organisms, organs, tissues, seeds, etc., and/or any part thereof, which may be alive or dead, and/or harvested, taken, removed, etc., from one or more living organism(s). Such “biomass” may also include any such biomaterial(s) that have been further processed, cut, ground, chopped, shaved, digested, broken down, etc., from its original form, such as to reduce the size and/or volume of individual particles or pieces of the biomaterial and/or to make the biomaterial more uniform or usable.

Such “biomass” may further include certain solid or particulate portion(s) or component(s) of such biomaterial(s) that have been selectively sorted, extracted and/or separated from the rest of the biomaterial. Indeed, such “biomass” may include portion(s), substance(s), material(s), etc., of any such biomaterial(s) that are at least partially or mostly purified, isolated, extracted, sorted, separated, etc., from other component(s) of the biomass material(s). Examples of such “biomass” that may be used with the present invention may include one or more of: plant material(s), such as wood chips, wood shavings, saw dust, grains, grasses, plant fibers, etc., biofuels, crops, various foodstuffs and food ingredients, such as coffee, tea leaves, etc., animal feed, such as food pellets, etc., or ingredients thereof, and/or other biological material(s), such as animal tissues, parts, organs, meat, etc., and/or algae, yeast, microorganisms, etc., and/or human or animal waste, such as animal manure, solid waste, sewage, garbage or municipal waste, food waste, etc. Such “biomass” may also include any combination of two or more biomaterials described above. Such “biomass” may further include other substances or additives that may be added to any such biomaterial(s) to affect the chemical or other properties of the biomass.

For purposes of the present invention, the term “organic material” may refer to any substance(s) or material(s) having at least a solid or particulate component(s) comprising organic compound(s) regardless of its/their source. Indeed, such “organic material” may be derived from natural, biological, and/or synthetic sources or processes. Thus, there may be substantial overlap in the meanings of the terms “biomass,” etc., and “organic material.” However, the term “organic material” may include additional materials not derived from a living organism. Such an “organic material” may refer to an earthly material, such as dirt or fossil fuels including coal, peat, etc., and synthetic polymers, fibers, etc., not obtained directly from a living source.

Dehydrating and drying a biomass material may be used for a variety of purposes as mentioned above. In addition to improving its combustibility and/or burning characteristics by reducing the moisture content of a material used as a fuel for burning, drying of a biomass or organic material may have other non-fuel benefits including: reducing the volume (and/or increasing the density) of the material for its easier and more efficient storage or shipment; converting a liquid, syrup, suspension, slurry, etc., containing a solid biomass or organic material into a solid form of the material that may resist spoiling to a greater extent; and killing any microbes or invasive plant species (in the form of seeds or otherwise) by heat during the present drying processes, such that the spread of infection (to humans or animals) and/or the invasion of weeds or unwanted plants may be avoided (e.g., due to pathogens, seeds, etc., that may be present in the material being heat-killed). As a few examples, a dry foodstuff or commodity, such as tea leaves, herbs, etc., may be prepared by embodiments of the present invention, the moisture content of a fossil fuel, such as peat, etc., may be reduced for improved burning, or a sewage product may be dried for its easier or more effective disposal.

As discussed further below, it is also proposed that combining the present drying process with the addition of an additive, such as glycerine, may further improve the properties of a material (e.g., by making it more hygroscopic, dense and combustible). By becoming more hygroscopic, the material may have improved absorption properties for cleaning spills, wastes, etc., and by becoming more dense, less of the dried product may become suspended and blown around into the environment while being dried, processed, handled, etc. By improving its burn properties, combustion of the material may produce more heat, fewer byproducts and/or less buildup inside a burner unit. For example, burning of manure from certain types of animals, such as chicken manure, can result in buildup of a hard substance on interior surfaces of a burner unit that can be very difficult to remove. Burning of some types of manure can also produce noxious or toxic byproducts, such as alkydes, that can be harmful or unpleasant to persons nearby. Thus, by burning these materials more thoroughly at a lower temperature due to the presence of a very flammable and/or clean-burning additive, such as glycerine, less product buildup and formation of harmful byproducts may occur.

Unlike prior systems and methods, the apparatuses and methods of the present invention utilize hot water or liquid supplied to a sleeve or jacket that directly surrounds one or more elongated auger tube(s) containing the biomass or organic material to be dried. Although the present invention is generally described as utilizing hot water as the heating source, other hot fluid(s) or liquid(s), such as oils, etc., could also be supplied to the sleeve(s)/jacket(s) to heat the material inside the auger tube(s). These other types of hot fluids would generally have boiling points that are high enough for the fluid to remain as a liquid and not evaporate to a significant extent at elevated operating temperatures. For example, oil(s) may be used at temperatures in a range from about 200° F. to about 400° F. while still remaining in liquid form. The ability to achieve much greater temperatures with oil(s) (relative to liquid water) may improve drying of a material, even if the amount of heat transfer from the oil(s) at a given temperature is less efficient than water, due to the greater difference in temperature between the oil(s) and the material being dried. Liquid(s) including water may also have other additives, such as glycol, that may be used to elevate the boiling point of the liquid, such that it can carry and deliver more heat to the material while remaining in liquid form. For example, a liquid mixture of water and glycol may be able to reach a temperature of about 210° F. without significant evaporation. As much as 50-60% glycol content or higher may be present with water.

The present apparatuses and methods may further provide for a flow of air or gas inside the tube(s) containing the biomass or organic material over most or all of its length to assist in the removal of water vapor, moisture, humidity, and/or other evaporated liquids from the interior of the tube(s). The flow of air or gas may be caused either by pushing of pulling of the air of gas through the auger tube(s) by a fan or blower in fluid communication with the interior(s) of the auger tube(s). The flow of air or gas inside the tube(s) may generally be in either direction through the auger tube(s) but may preferably be in a direction that is in the same direction as the direction of movement of the biomass or organic material through those tube(s) caused by the action of the auger(s) present therein. Such a flow of air or gas may be generated by a fan or blower present at or near a final exit opening of the auger tube(s) pulling the air or gas through the auger tube(s). However, the flow of air or gas inside the tube(s) may alternatively be in a direction that is counter or opposite to the direction of movement of the biomass or organic material through the tube(s) Such a flow of air or gas through the auger tube(s) may help to augment or optimize the carrying away and removal of the water vapor, evaporated liquid or solvent, etc., from the biomass or organic material inside the tube(s).

The present inventors have discovered that the combination of these two main conceptual features of the present invention (i.e., heating of the biomass or organic material by hot water in a jacket or sleeve surrounding tube(s) and flowing of air or gas through the auger tube(s) directly in contact with the biomass or organic material to be dried) results in effective and efficient drying of the biomass or organic material if carried out over a sufficient length of auger tube(s). Moreover, the mixing, churning, etc., of the biomass or organic material caused by the action of the auger(s) inside the tube(s) may further help to promote the efficient and thorough drying of the biomass or organic material traveling through the tube(s). The net effect of combining these conceptual features of the present invention results in a unique and highly effective method for drying, etc., a “wet” biomass or organic material. Depending on the length of time that the material is exposed to the heat source and the difference in temperature between the heat source (e.g., hot water) and the material being dried, more or less material may be dried, and a given amount of material may be dried to a greater or lesser extent. Thus, to increase drying capacity, an apparatus of the present invention may have a liquid heat source supplied to the sleeve(s)/jacket(s) of a dryer at a hotter temperature, and/or the material being dried may travel through a greater length of the auger tube(s).

Prior methods for drying various materials by heating have used steam, heated gasses or exhaust, etc., that can achieve much higher temperatures than liquid water. These methods may also have relied on the use of tumblers, shakers, etc., to help with drying. Previously, it was generally believed that liquid water could not reach a high enough temperature to provide enough heat transfer with standard drying equipment to effectively dry a wet material. However, the present drying method, apparatus and system overcomes the energy input limitations of using hot water as a heat source to dry material(s) by spreading out the drying process over a sufficiently long distance within one or more auger tube(s) in combination with a flow of air or gas that contacts the biomass or organic material inside the tube(s) to help pull away water vapor, solvent, etc., evaporating from the material being dried. The churning, mixing, etc., of the material by the rotating auger(s) inside the interior space or lumen (i.e., the interior) of the auger tube(s) further enhances this drying process and makes it more homogeneous and uniform. In addition, the auger(s) may have other structures and features, such as fins, projections and the like, that help to increase the churning and agitation of the material being dried. To facilitate the flow of air or gas through the tube(s), the auger(s) inside the tube(s) may also have holes that permit or facilitate the flow of air or gas through them. Although the presence of the holes may allow some of the air to flow lengthwise, the helical shape of the augers may also cause much of the air to flow in a helical pattern through the auger tubes, which may cause greater intermixing of the material and air inside the tube(s). Such increased mixing of material and air may also cause more moisture to be evaporated and carried away from the material to increase its drying. Various other structures, such as fins and the like, may also cause greater mixing and non-laminar flow of air to increase evaporation.

By utilizing hot water as the source of energy for the drying system, apparatus and method of the present invention, many of the safety concerns with prior methods that use hot gases, fumes, vapors, etc., are avoided. In general, containment of hot gases, etc., raises many safety issues and concerns due to the potentially high pressures involved that may also fluctuate and/or surge over time. High pressures above safety thresholds or limits can be extremely dangerous and lead to explosions, ruptures, etc., of pipes, etc., used to contain those hot gases. Thus, machines and equipment relying on the containment and/or controlled flow of hot gases, etc. (e.g., as opposed to hot water), require more expensive and elaborate precautions be taken with heightened engineering requirements and safety controls as well as the use of heavier duty components, pipes, etc., for such machines and equipment to be considered safe.

In contrast, the use of hot water or other liquid as proposed by the present invention generally does not suffer from these same issues relating to high temperatures and pressures that may fluctuate or surge over time. Furthermore, sources for hot water are much easier to find and obtain and are commonly present in homes, office buildings, factories, etc. Even when ready sources of hot water are not available or convenient, hot water may be generated more easily with less energy input than steam or other hot gases. In addition to being generally more accessible and easier to generate and use, hot water may also be produced and used at much less cost, without as much heavy duty equipment, and with fewer safety precautions being required. Therefore, the ability to use hot water (instead of hot exhaust or gases) as an energy source to effectively dry a biomass or organic material is a key advantage of the present invention.

Yet another advantage of using hot water is the fact that it may be generated by the same process that utilizes the dried biomass material being produced by the present drying apparatus and method. According to some embodiments, for example, the dried biomass material being produced by the method, apparatus and system of the present invention may be used as a fuel in an associated burner unit, and the hot water for the present drying method, apparatus and system may be heated and supplied by (and obtained from) the associated burner unit that is being fed the dried biomass material. The energy generated by the burner unit that is used to heat the water for the dryer apparatus of the present invention may be less than the total energy produced by the burner unit, such that surplus energy from the burner unit may be used for other purposes. The heated water itself may also be recycled and/or used for other purposes.

Thus, the drying method, apparatus and system of the present invention may be used in combination with a burner unit to provide a partially or mostly closed loop system that is more efficient and/or sustainable due to its recycled use of energy. As introduced above, hot water produced by a burner unit may be supplied to the drying apparatus of the present invention, which may then use the heat supplied by the hot water to heat and dry a biomass material, which may then be fed into the burner unit as a fuel to generate heat energy used to heat water supplied to it. Thus, heated water may then be fed back to the present dryer apparatus to complete this heating/drying cycle in combination with the burner unit.

The drying apparatus or device of the present invention may generally include at least one auger tube(s) of sufficient length with the auger tube(s) being surrounded by a jacket or sleeve for carrying hot water. Each of the auger tube(s) are generally elongated in shape with a longitudinal dimension that is much greater than its width or diameter. Each auger tube encloses an interior space or lumen (i.e., an “interior”) of the auger tube that is also elongated in the longitudinal dimension of the respective auger tube. Each auger tube may be described as having a first end and a second end, the first end and the second end being on opposite longitudinal ends of the auger tube. Each auger tube may also have an input opening (for receiving the material being dried into the interior of the auger tube) and an output opening (for allowing the material to exit the interior of the auger tube), wherein the input opening is at or near the first end of the auger tube and the output opening is at or near the second end of the auger tube. The phrase “at or near” in reference to one of the longitudinal ends of an auger tube refers to a position or location that is closer to that longitudinal end of the auger tube than to the middle or halfway point between the two opposing longitudinal ends of the auger tube.

When two or more auger tube(s) are used as part of a dryer apparatus of the present invention, they are generally assembled in an end-to-end arrangement in series, such that a biomass or organic material entering a proximal and/or input end of a first auger tube (i.e., through an input opening) will travel the distance of that auger tube and exit its distal and/or output end (i.e., through an output opening). Upon or after exiting the distal or output end of the first auger tube (i.e., through the output opening), the biomass or organic material may then enter a proximal and/or input end of the next (second) auger tube in the series (i.e., through its input opening), and so on. This biomass or organic material continues to travel through these successive auger tubes until the material exits the last auger tube in the series (i.e., through a final output or exit opening) as a final dry product for use in a subsequent process. The movement of the material through the auger tube(s) is caused by the action (i.e., rotation) of auger(s) present inside the auger tube(s)—i.e., typically one auger per auger tube. The rotation of each of the auger(s) is also driven or powered by a respective auger motor that is physically coupled to that auger at or near one of its longitudinal ends. An auger motor could conceivably power the rotation of two or more augers. More preferably, however, rotation of each of the augers will instead be powered by its own auger motor (i.e., one auger motor for each auger).

According to embodiments of the present invention, a drying apparatus may be able to dry about 500 pounds (or about 227 kilograms) of biomass per hour with an approximately 25% drop in moisture (e.g., with glycol/water mixture at 210° F. and the material traveling through 80 feet of auger tube length). However, this is only an example, and other amounts of material and/or other percentage changes in moisture content are also possible. As mentioned above, the amount of dried material that can be produced (as well as the extent or amount of drying) with a dryer apparatus of the present invention will depend on the amount of time that the material is exposed to heat and the amount of heat present, which will depend at least in part on the length of the auger tube(s) and the temperature of the liquid heat source. Thus, an apparatus of the present invention may be ideal for smaller scale applications in which large production amounts of dried material are not needed. Although the apparatus of the present invention may be used and adapted for large scale production, such larger scale drying operations may utilize hot gases that can reach much higher temperatures for improved production capacity—in such cases, the higher production levels may justify the added costs, difficulties and safety concerns with these types of machines and equipment as noted above.

A series of two or more auger tubes may be assembled or constructed together with at least the output end of one auger tube positioned above at least the input end of the next auger tube in the series, such that the material being dried may fall, such as by gravity, from the previous auger tube (i.e., through its output opening) into the next auger tube in the series (i.e., through the input opening of the next auger tube). This basic arrangement will utilize auger(s) present inside the auger tube(s) to carry the material from the input end to the output end of the respective auger tube. The auger(s) inside an auger tube may also raise the material to a higher position above the ground if the longitudinal axis of the auger tube is inclined. However, two or more auger tubes in series may more preferably be arranged in “levels” in a basically horizontal orientation along their longitudinal axis. These levels of auger tubes may also be stacked on top of each other for conserving space. For purposes of the present invention, the term “longitudinal” shall refer to the direction or axis that is aligned with the lengthwise or longest dimension of an auger tube, auger or a stack of auger tubes. Although a present drying apparatus may generally use gravity to assist or cause the material being dried to be transferred from the output end of one auger tube to the input end of the next auger tube in the series, it is conceivable that the material may instead be raised, moved, lifted, etc., by use of an additional auger, conveyor, etc., from an output end of one auger to the input end of the next auger in the series (even though this may be less preferred). In such a case, the output end of one auger tube may not need to be positioned above the input end of the next auger tube.

The two or more auger tubes of a present drying apparatus may be positioned in a variety of different three-dimensional arrangements, orientations, patterns, etc. When viewed from above, a series of two or more auger tubes may be assembled end-to-end in a straight or curved line, in a zig-zag arrangement, in a circular or other partially or fully closed loop arrangement, etc., or any other suitable arrangement or pattern. For example, on a factory or production floor, the pattern of end-to-end auger tubes when viewed from above may wind around and between the placements of other factory equipment for efficient usage of floor space.

According to embodiments of the present invention, the two or more augers may be positioned such that the auger tubes are positioned longitudinally generally within a horizontal plane or a volume of space that is higher off the ground than the horizontal plane or volume of space occupied by the next auger tube in the series (if present). According to other embodiments, however, one or more of the auger tube(s) may be angled upward toward its distal and/or output end to raise the drying material above the input end of the next auger tube (if present). However, it may generally be more preferred for two or more auger tube(s) of a drying apparatus of the present invention to instead be stacked on top of each other in horizontal and/or parallel “levels” (as introduced above) to reduce and conserve the amount of floor space occupied by the present drying apparatus. With this kind of arrangement, the two or more auger tube(s) may be stacked on top of each other to basically share the same floor footprint.

Such a stacking arrangement of two or more auger tubes of a present drying apparatus may comprise those tubes being arranged in a down-and-back arrangement, such that the material being dried exits a distal output end of one (first and/or upper) auger tube (i.e., through its output opening) and drops into a distal input end of a next (second and/or lower) auger tube in the series (i.e., through its input opening; the next auger tube being below the previous upper auger tube in the series) to flow back in a proximal direction. With this arrangement, the longitudinal axes of the two or more adjacent auger tubes in the series may be generally or approximately in parallel with each other and/or horizontal in relation to the ground.

With a stacked arrangement of two or more auger tubes, each pair of vertically adjacent auger tubes in the series (each pair including an upper and lower tubes) may have the proximal end of the upper tube positioned above the proximal end of the next lower tube and the distal end of the prior upper tube positioned above the distal end of the next lower tube. Thus, if the material inside the prior (upper) auger tube is flowing distally, the material may exit a distal output end of the prior (upper) auger tube (i.e., though its output opening) and fall into a distal input end of the next (lower) auger tube (i.e., though its input opening) to flow proximally from there through the next lower auger tube. On the other hand, if the material inside the prior upper auger tube is flowing proximally, the material may exit a proximal output end of the prior upper auger tube (i.e., though its output opening) and fall into a proximal input end of the next lower auger tube (i.e., though its input opening) to flow distally from there through the next lower auger tube.

In addition to the material flowing into or out of the auger tube interior through the input and output openings, respectively, at either the proximal or distal ends of an auger tube, each auger tube may itself be composed of two or more segments that are assembled together, such that the material flows continuously through the segments of the auger tube (e.g., within a level of a stack). A stack of two or more auger tubes may also be assembled together as two or more stacked segments (with each stacked segments having auger tube segments for each level of the stack). Indeed, as explained further below, two or more auger tubes may be assembled together in segments, sections, etc., as part of the same level of a stacked arrangement, such that the material being dried may flow continuously through the segments, sections, etc., within that level of the stacked arrangement. The segments of an auger tube may generally be assembled end-to-end such that their interiors are continuously enclosed. Typically, these segments of an auger tube will be aligned and collinear with each other. As an example, a material flowing distally through a first segment or auger tube may exit a distal end of the first segment or auger tube and enter a proximal end of a second segment or auger tube within the same level of the stacked arrangement. Thus, the material will only fall into a lower level auger tube only when it reaches the distal end of all of the auger tube(s) or segment(s) within that level of the stacked arrangement. The same may be true for material flowing proximally through two or more auger tube(s) or segment(s) within the same level of the stacked arrangement with the material falling into a lower auger tube only when it reaches the proximal end of all of the continuous auger tube(s) or segment(s) within that level of the stacked arrangement

For purposes of the present invention, the terms “proximal” or “proximally” refer to a direction or end of an auger tube, stack, etc., that is relatively closer to or toward where the biomass or organic material to be dried first enters the auger tube(s) or an extension thereof (e.g., through an initial input opening), such as from a hopper, bin, container, etc., along the path of the auger tube(s). On the other hand, the terms “distal” or “distally” generally refer to a direction or end of an auger tube, stack, etc., that is relatively farther away from where the biomass or organic material to be dried first enters the auger tube(s) or an extension thereof (e.g., through the initial input opening) along the path of the auger tube(s).

When two or more auger tubes are stacked on top of each other, the proximal and distal ends or directions of the auger tubes are aligned or parallel with a single proximal-to-distal axis (i.e., relative to where the material first enters the auger tube(s)—e.g., through an initial input opening) without regard to the direction of flow of the material in the respective tube(s). However, when a series of auger tubes are positioned end-to-end in a more extended arrangement (linearly or otherwise) with the auger tubes not stacked on top of each other, then the longitudinal axes of the auger tube(s) may be more freely arranged in space relative to a single proximal-to-distal axis (i.e., the “proximal” and “distal” ends or directions of the one or more of the auger tube(s) may not be positioned along (or parallel to) a single proximal-to-distal axis (e.g., relative to the initial input opening)). According to some embodiments, a more extended arrangement of auger tube(s) (i.e., not stacked) may be aligned with the direction of flow of the biomass or organic material through the auger tube(s). With this arrangement, however, it is possible that an output end of one auger tube may be closer (or more proximal) to where the material first enters the auger tubes (e.g., through an initial input opening) than an output end of a previous tube(s) in the series. For example, if the series of end-to-end auger tubes were arranged such that they looped back toward where the material first entered the input end of the first auger tube in the series (e.g., through an initial input opening), then the output end of the later auger tube(s) in the series may be positioned more proximally than their input ends and/or the output end(s) of the previous auger tube(s) in the series.

According to many embodiments of the present invention as introduced above, each “level” of the stacked auger tubes may each comprise two or more segments, etc., of auger tubes. Constructing the auger tubes in sections or segments allows for the total length of the auger tube(s), through which the biomass or organic material travels to be increased or decreased in a modular fashion (i.e., by adding or subtracting the number of these segments). According to some of these embodiments, each segment or section may comprise a top (or upper) auger tube and a bottom (or lower) auger tube, such that the respective upper auger tubes and the lower auger tubes of the adjacent segments may be joined continuously together. The upper tubes may be configured to move the material distally, whereas the lower tubes may be configured to move the material proximally, or vice versa. The length of each of the stacked segments may vary but may be about 15 to 25 feet, or about 20 feet, in length, and the total length of the stack (e.g., of assembled stack segments) may reach about 75 to about 80 feet or more. With an upper/lower stacking arrangement, an auger tube stack segment length of 20 feet would translate into about 40 feet of auger tube through which the material travels (due to the down-and-back arrangement). If two of these auger tube stack segments were joined, then the auger tube stack would be 40 feet in length, which would translate into about 80 feet of auger tube through which the material travels. Alternatively, the auger tube(s) may not be assembled in segments, and the total length of an auger tube may be about 15 feet to about 45 feet or more.

According to some embodiments, it is also possible that more than two “levels” of stacked auger tube(s) may be used, which may also be assembled as segments having more than two “levels” of stacked auger tube(s) per segment. For example, three stacked auger tubes, including a first auger tube, a second auger tube and a third auger tube, may be stacked on top of each other with the first auger tube on top, the second auger tube in the middle and the third auger tube on the bottom. With such a “down-and-back-and-down again” arrangement, the first and third auger tubes would move the material distally, and the second auger tube would move the material proximally. Likewise, four or more stacked auger tubes could be used, and so on. Based on the description provided herein, one skilled in the art would understand that a number of different stacking and/or other arrangements of the end-to-end auger tubes are possible according to embodiments of the present invention.

Regardless of the exact configuration, the biomass or organic material may be delivered to the only auger tube or a first auger tube in a series of auger tube(s) from a bin, hopper, container or the like. For purposes of the present invention, terms indicating order, such as “first,” “second,” “last,” etc., in reference to the auger tubes shall refer to their functional placement in the series of auger tubes according to the flow of the material being dried. Thus, a “first” auger tube would receive the material before a “second” auger tube, and so on. For example, the biomass or organic material may be initially contained in a hopper or bin that may hold an amount of material in a range from about 2-10 cubic yards or more (e.g., about 4 cubic yards), although the size of the bin, etc., may obviously vary. The shape of the bin, etc., may also vary but a circularly shaped bin, etc., may be preferred to accommodate rotating agitators. The bin, hopper, etc., may be positioned at or near a proximal end of the first auger tube in the series of auger tubes, or at or near a proximal end of the only auger tube of the dryer. According to some embodiments, an extended proximal tube, which may be an extended proximal portion of the first (or only) auger tube, may have an initial input opening, which may be present in the top of the extended proximal portion, for receiving the biomass or organic material. This extended proximal tube may be aligned longitudinally and/or collinear with the first (or only) auger tube, and continuous with, and/or part of, the first (or only) auger tube, for delivery of the biomass or organic material from the extended proximal tube into the first (or only) auger tube. If the extended proximal tube is part of the first (or only) auger tube, the extended proximal tube may be referred to as an extended proximal portion of the first (or only) auger tube, and the remainder of the first (or only) auger tube may be referred to as a main portion of the first (or only) auger tube to distinguish it from the extended proximal portion of the first (or only) auger tube. Thus, even if continuous and collinear with the first (or only) auger tube, the extended proximal tube may be separate from the first (or only) auger tube and/or have its own separate auger.

The auger in the extended proximal tube or portion may be different, separate and distinct from the auger in the first (or only) auger tube, or main portion thereof. Thus, the auger in the extended proximal tube or portion may have a different flighting pitch and/or diameter than, and/or may be rotated independently of, the auger in the first (or only) auger tube, or main portion thereof. At a given rate of rotation, the pitch may affect or determine the amount and rate of flow of the material through the respective auger tube or through a respective portion of the auger tube. The extended proximal tube or portion may be aligned and collinear with the first (or only) auger tube, or main portion thereof, and regardless of any differences in pitch, the auger(s) of the respective extended proximal tube or portion and (the main portion of) the first (or only) auger tube may be rotated together by the same motor and may have a common or physically coupled auger shaft(s). More preferably, however, the respective augers of the extended proximal tube or portion and the first (or only) auger tube, or main portion thereof, may be physically separate and/or rotated separately and/or independently of each other (e.g., at different rates) by different and/or separate motors, such that their rotation may be independently controlled. With such embodiments, the rate of rotation of the auger in the extended proximal tube or portion may be regulated and controlled independently of the auger(s) inside the auger tube(s) to control the “feed rate” of material entering a first (or only) auger tube from the extended proximal tube or portion, which may enter the extended proximal tube or portion (e.g., through an initial input opening) from a bin, hopper, etc. Alternatively, the extended proximal tube or portion may be absent, and the material may enter the first (or only) auger tube through an initial input opening, such as a top input opening, of the first (or only) auger tube.

The hopper, bin, etc., may be positioned at least partially above the first (or only) auger tube, and/or above the extended proximal tube or portion, and the biomass or organic material loaded in the hopper, bin, etc., may fall by gravity into an initial input opening of the first (or only) auger tube or the extended proximal tube or portion. Continuous and even transfer of material from the hopper, bin, etc., into the initial input opening of the auger tube(s) may be facilitated or encouraged by action of rotating stir bar(s) or agitators inside the hopper, bin, etc. The hopper, bin, etc., may also be circular in shape when viewed from above to work in tandem with rotating stir bars, agitators, etc. A hole or opening may also be present in the floor of the hopper, bin, etc., and aligned, continuous and/or connected with an input opening of the auger tube(s) to allow the material to drop or fall into the first (or only) auger tube or the extended proximal tube or portion, such as through the hole/opening in the floor of the hopper, etc., and the initial input opening of the first (or only) auger tube or the extended proximal tube or portion. Alternatively, the biomass or organic material may not be transferred directly from a hopper, bin, etc., but may instead be transferred to the initial input opening of the auger tube(s), etc., by any other suitable delivery or feeder mechanism such as by another auger tube, elevator screw, chute, conveyor, etc., or even by hand.

According to embodiments of the present invention, each of the auger tube(s) may have a diameter that is slightly greater than the diameter of the auger flighting of the auger(s) disposed therein. The diameter of the auger tube may depend on the size of the dryer, the amount of material that may be dried, the diameter of the auger inside it, and the desired spacing between the auger tube and the sleeve/jacket. The diameter of the auger tube(s) may vary within reasonable limits, but may be in a range from about 10 inches to about 30 inches or greater, or from about 10 inches to about 20 inches, or from about 10 inches to about 16 inches, or about 13 inches, or about 15 inches. The spacing between each of the auger(s) and their respective auger tube may vary but may be in a range of from about a ¼ inch (or less) to about 2 inches (e.g., a diameter that is about ¼ inch to about 4 inches less than the auger tube), or about ½ inch to about 1 inch (e.g., a diameter that is about ½ inch to about 2 inches less than the auger tube). The auger tube may have a slightly greater diameter than the auger inside of it, such as to prevent binding of the material. The auger(s) themselves may thus be only somewhat smaller than the auger tube that they are in, such as in a range of from about 8 inches to about 20 inches, or from about 8 inches to about 15 inches, or about 10 inches, or about 12 inches, or about 14 inches.

Each auger may be supported on both ends (e.g., proximal and distal), such that the gap between the auger and the surrounding auger tube is constant around its circumference. Alternatively, an auger may not be supported on one end (e.g., the end opposite the motor), such that the auger rests on at least a bottom inner surface of its respective auger tube. In such a case, the gap or spacing between the auger and its tube would only be in the upper portion of the auger tube since the auger would be contacting the lower part of the auger tube, and the spacing in the upper portion of the tube would also be the difference in diameter between the auger and the auger tube. Although the cross-sectional shape of the auger flighting(s) and the auger tube(s) may vary, they may generally be circular to allow for free rotational motion.

A jacket or sleeve surrounding the auger tube is also generally positioned around most or all of each of the auger tube(s) to define and enclose an elongated jacketed space between the auger tube and the jacket or sleeve. The jacket or sleeve as well as the enclosed jacketed space may have an elongated dimension that is aligned or in parallel with the elongated dimension of the associated auger tube. A hot water or liquid may flow through the enclosed jacketed space in a direction that is parallel to the longitudinal axes of the auger tube(s) and the sleeve or jacket. The jacket/sleeve may receive the hot water or fluid through an input port at or near a first end of the jacketed space and allow the hot water or fluid to exit through an output port. The jacket or sleeve may have a constant cross-sectional shape along its length that may also be the same as (albeit larger than) the cross-sectional shape (e.g., the circular shape) of its associated auger tube. The jacket or sleeve may typically be an outer tube that completely surrounds the inner auger tube (e.g., in a concentric fashion), but the outer jacket or sleeve may instead mostly, but not completely, surround the inner auger tube (e.g., surround more than 50% of the cross-sectional circumference, more than 75% of the cross-sectional circumference, or more than 90% of the cross-sectional circumference of the inner auger tube).

The auger tube(s), auger(s) and sleeve/jacket may each be made of metal, such as steel, to be sufficiently strong to withstand the mechanical forces and higher temperatures during operation. Each sleeve/jacket surrounding its respective auger tube may have a diameter that is slightly or somewhat greater than the auger tube to define a space between the auger tube and sleeve/jacket. Thus, the diameter or radius of the sleeve or jacket may be defined in terms of a difference relative to the respective auger tube. For example, the difference in diameter may be in a range from about ½ inch to about 2 inches, or about 1 inch greater than the diameter of the auger tube. According to many embodiments, the jacket or sleeve may be positioned such that it is concentric (or approximately concentric) with its associated auger tube. In such cases, if the jacket/sleeve and the auger tube have the same shape, then the spacing between them will be consistent in cross-section around the periphery of the auger tube. However, the jacket/sleeve may alternatively not have the same shape and/or be concentric with its associated auger tube. In such a case, the spacing of the jacketed space may be different in cross-section and/or change around the periphery of the auger tube.

According to embodiments of the present invention, the “handedness” of each of the augers within an auger tube(s) may depend on the intended direction of flow of the biomass or organic material to be dried in the respective auger tube as well as the direction of rotation of that auger. As mentioned above, the pitch of the auger flighting may vary depending on the desired amount or rate of flow of material over time through a given portion of the auger tube at a given speed or rate of rotation of the auger(s). However, the auger pitch may preferably be constant through most or all of the length of a given auger tube. The augers may also have additional structures, such as fins, projections or the like, that may augment the churning of the material being dried as it travels along the length of the auger tube, which may help with drying. Each of the augers may also have a plurality of holes through it (i.e., through the fighting) to facilitate the longitudinal flow of air or gas through the auger tubes to assist in drying of the material. The combination of the augers and holes may also encourage a spiraling or helical flow of air/gas longitudinally (i.e., end-to-end) through the length of the auger tube(s). As will be mentioned below, such longitudinal flow of air/gas may be driven by a fan or blower, which may be positioned at or near a final output end of the auger tube(s).

Hot water may flow longitudinally inside a jacket or sleeve surrounding the auger tube (i.e., through a jacket/sleeve space between the jacket/sleeve and the auger tube) in either a proximal or distal direction, but may preferably flow in a direction that is counter to the direction of flow of the material being dried inside the respective auger tube. It is believed that a counter flow of hot water provides more efficient drying of the biomass or organic material. Additional structures may be present between the auger tube and the jacket/sleeve, such as to support the jacket/sleeve. According to some embodiments, these and other structures, such as flaps, etc., may also be positioned to impede or cause more helical or turbulent flow of the hot liquid through the jacket or sleeve (i.e., to discourage simple laminar flow). By forcing more mixing or turbulent flow, more effective heating of the material may be achieved. The spacing between the outer jacket or sleeve and the inner auger tube may vary but may preferably be constant. As mentioned above, such spacing may be about 1 inch, although a range of other spacings are also possible.

Generally, the hot water used to heat the drying material will preferably travel inside the jacket(s) or sleeve(s) (i.e., through a jacket/sleeve space between the jacket/sleeve and auger tube) along most or all of the total length of the auger tube(s), through which the material being dried is traveling. However, it is conceivable that the hot water may instead flow along only a portion or subset of the total length of the auger tube(s) and/or not along all of the auger tube(s). The hot water may be delivered at a rate of about 10 gallons per minute per about 20 feet of auger tube(s), but a range of delivery rates are also possible depending on the amount and type of material being dried. In general, a longer auger tube will require a greater flow of hot water or other liquid due to the loss of heat by transfer from the hot water/liquid to the material (and thus a decrease in the temperature difference between the hot water/liquid and the material) over the length of the tube. It is estimated that a flow rate of approximately 10 gallons per minute of hot water may be required for approximately 100,000 Btu of heat transfer to a material being dried. Thus, 40 feet of auger tube(s) may require 20 gallons per minute, and 80 feet of auger tube(s) may require about 40 gallons per minute. However, these amounts and flow rates are approximations, and actual amounts and rates may vary.

The temperature of the hot water or liquid initially delivered to the jacket/sleeve of the auger tube(s) (i.e., a starting temperature or a starting water temperature) will generally be below the boiling temperature of the water or liquid, but may preferably be in a range from about 160° F. to about 210° F., or more preferably in a range from about 185° F. to about 210° F., in the case of water (perhaps with another additive—e.g., a water/glycol mixture). For liquids other than water, much higher temperatures may also be possible. As mentioned above, a liquid other than water, such as an oil(s), may instead be used having a much greater initial temperature than water (e.g., in a range from about 200° F. to about 400° F.) while still remaining as a liquid. In general, a higher temperature for the water or liquid entering the dryer (i.e., the starting temperature or the starting water temperature) would be preferred to increase and improve drying, but this may depend on, or be limited by, the heat source or the amount of available energy. The minimum temperature for the water or liquid exiting the dryer (i.e., an exit (or output) temperature, such as a water exit temperature) may also vary, but may preferably be greater than or equal to about 160° F., about 165° F., or about 170° F., or about 175° F., or about 180° F. in the case of water.

On the other hand, the temperature of the water or liquid exiting the dryer apparatus (after flowing through the sleeve/jacket spaces(s)—e.g., an exit temperature or a water exit temperature) will generally be less than the starting temperature since energy and heat is consumed in the drying process. Since the starting temperature will generally depend on external factors and should usually be constant, the dryer apparatus may measure and monitor the exit temperature (or water exit temperature) to determine the operational state and performance of the dryer apparatus. As will be explained further below, operational parameters may be adjusted based on the measured water exit temperature, and if the water exit temperature falls too low, then the system may commence a shutdown sequence to bring the water exit temperature back up. It also possible for there to be minimum and/or maximum shutdown temperature(s) to ensure that the machine operates within safety limits, which may be defined in terms of a positive or negative offset relative to a target temperature. For example, if the water exit temperature is outside these tolerable limits and exceeds the maximum temperature and/or falls below the minimum temperature, then a number of different safety triggers may cause the hot water source, the hot water pump, and/or the dryer itself (or any one or more of its components) to pause or shutdown. Indeed, the minimum water temperature may also be referred to as a (minimum) shutdown temperature.

The water exit temperature is a measured value, but the water run temperature (or target water temperature) as well as any minimum and maximum temperatures (or temperature offsets) may be preset, hard-coded by the manufacturer, and/or selected or changed by a user. Since the temperature of the hot water delivered to the dryer will generally be constant (assuming a constant energy or heat source used to heat the water), the temperature of the hot water exiting the dryer will provide more information about the operating state and condition of the dryer apparatus since the drying process consumes energy. A greater drop in water temperature while passing through the dryer would indicate that a greater amount of heat was absorbed and consumed in drying the material, which may provide an indication about the amount and/or moisture content of the material being dried (e.g., the amount of evaporation). Therefore, the water exit temperature may be measured at a location or position at or near where the hot water exits the dryer. The target water temperature may vary, but may be a temperature within a range from about 160° F. to about 205° F., or alternatively about 165° F. to about 205° F., or about 170° F., or about 175° F., or about 180° F., or about 185° F., or about 190° F., or about 195° F., or about 200° F., or about 205° F. in the case of water (with or without an additive, such as glycol. Any minimum and maximum temperature limits, such as a minimum or maximum shutdown temperature, may also be defined in terms of tolerable temperature offsets or limits (e.g., about ±5° F., or about ±10° F., or about ±15° F.) relative to a target water temperature (or a water run temperature), which may each be preset and/or selected by a user.

The hot water or liquid will generally be supplied to the space between the jacket or sleeve and the auger tube(s) at or near one end of an auger tube, such as by use of pipes or hoses from a hot water or liquid source, such as a water heater, burner unit, etc., and the hot water will then flow longitudinally through the interior of the jacket or sleeve toward the other (opposite) end of the auger tube. If the dryer includes a series of auger tubes, the hot water or liquid may then exit the interior of the jacket or sleeve at or near the other end of an auger tube (i.e., at or near the opposite end of the jacket/sleeve relative to where the water or liquid entered the jacket/sleeve) and enter at or near one end of the jacket/sleeve for the next auger tube in the series. Such flow from a jacket/sleeve surrounding a prior auger tube into a jacket/sleeve of a next auger tube may be more direct or continuous (i.e., through a continuous channel, opening, etc., between them), or via tubing, hoses, etc., between and connecting them. In the case of hot water or liquid flowing between the jackets/sleeves of successive auger tubes via tubing, hoses, etc., such flow may be from an output port of one jacket/sleeve to an input port of the next jacket/sleeve. For hot water or liquid flow that is counter to the direction of material flow through the tubes, the hot water or liquid may be initially be delivered into a jacket/sleeve surrounding the last auger tube in the series of auger tubes (e.g., through an input port), flow through the successive jackets/sleeves, and then exit through an output port of the jacket/sleeve for the first auger tube in the series (e.g., at or near its proximal end and/or the initial input opening).

According to some embodiments with a dryer apparatus having stacked auger tubes, in which the hot water or liquid flows in a direction counter to the flow of material through the dryer, once the hot water or liquid reaches the distal end of an auger tube and sleeve/jacket of the last auger tube in the series, it may be circulated from the sleeve/jacket space (e.g., at the distal end of the stack) surrounding that auger tube into the distal of the sleeve/jacket space surrounding the prior auger tube in the series for return flow of the hot water in the reverse direction. For example, in the case of a auger tube stack consisting of an upper and lower auger tubes, hot water may flow through a hose or tubing connecting a first output port of a lower sleeve/jacket surrounding a lower auger tube (of an auger tube stack at or near the distal end of the stack) and a second input port of a sleeve/jacket of an upper auger tube (at or near the distal end of the stack), such that the hot water may flow distally through the lower sleeve/jacket space, through the ports and hoses, and then proximally through the upper sleeve/jacket space.

The drying apparatus may also have an optional hammer mill for breaking up the biomass or organic material being dried. A hammer mill as understood in the art generally comprises an enclosed space or drum having an (upper) input opening as well as a (lower) output opening, a screen or mesh, and a plurality of rotating hammers arranged radially that together rotate around an axis of rotation (that may generally be horizontal relative to the ground) such that the hammers rotate in or along a generally vertical plane. The rotating hammers function to break up the material falling through them by gravity within the enclosed space or drum of the hammer mill into smaller pieces. The outermost portions, ends, edges, etc., of the hammers may also travel along and near a screen positioned near the bottom of the enclosed space of the hammer mill at or above the output opening. Rotation of the radially arranged hammers may be driven or powered by a hammer mill motor, which may for example be a 5 horsepower motor.

By action of the hammers against the screen the biomaterial may be broken up into smaller pieces that fall through the screen when individual particles or pieces of the material are (or become) small or fine enough to pass through the screen. Thus, the screen both works in tandem with the hammers to help break up the material, but it also functions to select the material passing through it on the basis of size with only sufficiently small pieces of the material passing through it and exiting the hammer mill. Various baffle(s) and/or other structure(s) may also be present to help confine and/or direct the flow of the material through the hammer mill and at least partly define the interior space of the hammer mill. The drum size of the hammer mill may be about 9 inches×16 inches, or about 14 inches×16 inches, although other sizes are possible. The rotation of the hammers of the hammer mill may be driven or powered by any suitable motor (e.g., a 10 horsepower electric motor). The screen size (in reference to the individual holes or pores in the screen) may vary depending on the type and “wetness” of the material as well as its intended use. For example, the screen size may be within a range from about 3/16 inch to about 1¼ inch, or alternatively in a range from about 5/16 inch to about 1 inch. Without being bound thereby, a larger screen size may be used for example, in drying biomass for burning as well as manure or other particularly wet materials. A smaller screen may be used for bedding or feed pellets. The closest distance or spacing between the outermost portions of the hammers and the screen may vary within a close range but may be in a range from about 1/32 inch to about ¼ inch, or from about 1/16 inch to about ⅛ inch.

The hammer mill may possibly be positioned at different locations in relation to the auger tube(s), but may preferably be placed to receive biomass or organic material that has travelled through at least one auger tube (e.g., at the output end of the first or only auger tube, at a distal output end of a series of auger tube segments, etc.), such that the material is at least partially dried. However, the hammer mill may preferably be placed somewhere between the first and last auger tubes in a series of auger tubes, such as between the first and second auger tubes in the series. Indeed, more effective operation of the hammer mill (i.e., avoiding the development of blockages or clumping due to accumulation of material) in many cases may rely on the material being at least partially dried prior to entering into the hammer mill since “wetter” materials are more likely to clump together (e.g., on the screen, etc.). Thus, the hammer mill may preferably be positioned such that it receives material that has already passed through at least one of the drying auger tubes. A relatively drier material will be more effectively and easily broken up into smaller pieces that fall through the screen without too much accumulation or clumping that might occur with a wetter material. When two or more auger tubes are positioned in a stacking arrangement, the hammer mill may preferably be placed at the distal end of the full stack of auger tubes. For example, biomass or organic material reaching and exiting the distal end of an upper level of auger tube(s) of the stack may fall into and through the hammer mill, and then exit the hammer mill and further fall into the distal end of a lower level of auger tube(s) for the material to travel in a reverse direction through the lower auger tube(s).

In addition to the auger tube(s), the hot water jacket(s)/sleeve(s), and the optional hammer mill, product bin, etc., an apparatus of the present invention may further include a blower system. The blower system may comprise at least one fan or blower. The fan or blower may generally be in fluid communication with the auger tube(s). For purposes of the present invention, the phrase “in fluid communication” in reference to two or more components of the present dryer apparatus (e.g., a fan or blower and one or more auger tube(s)) shall mean that they are configured, positioned and connected with each other via an enclosed space, such as via one or more tube(s), hose(s), pipe(s), opening(s), shaft(s), etc., or combinations thereof, such that a movement, flow, etc., of air or gas may be generally contained between the two or more components and/or directed or caused to move, flow, etc., through one or more of those component(s). For example, a fan or blower “in fluid communication” with one or more auger tube(s) may be positioned, configured, etc., to cause, force, etc., a movement or flow of air or gas to be directed or channeled into and through the interior(s) of the one or more auger(s). Any one auger tube may be in fluid communication with a blower via another auger tube.

The fan or blower will be in fluid communication with the interior of the auger tube(s) by physical connection or attachment to the auger tube(s). The fan or blower may potentially be positioned at different locations along the full length of the auger tube(s) but may preferably be positioned at or near the final output end of the last auger tube in a series of auger tubes or at or near the output end of the only auger tube (i.e., at or near the final exit opening of the auger tube(s) and in more direct fluid communication with the portion of the interior of the auger tube(s) at or near the final output end of the last (or only) auger tube). Although the blower may cause a flow of air or gas in either direction through the interior space or lumen (i.e., the interior) of the auger tube(s), the air/gas may preferably be pulled through the system from a position at or near the final output end of the auger tube(s) (e.g., such that the air/gas may flow in the same direction as the flow of material through the tube(s)). For example, the fan/blower may be positioned to pull air from the last auger tube, which may in turn pull air through the other auger tube(s) and/or hammer mill in the series all the way back to the original or initial input opening of the auger tube(s) where the material is first placed into the auger tube(s) (and/or through another opening or inlet nearby). According to some embodiments, the fan or blower may be in fluid communication with the interior of the auger tube(s) via a small enclosed space between the auger tube(s) and an incline or discharge auger or via a portion of the incline or discharge auger. It is conceivable that a fan or blower may be placed elsewhere in the series—even at or near the input opening of the auger tube(s), and/or the blower/fan may push, rather than pull, air/gas through the system. The fan or blower may also be arranged such that it pushes/pulls air flow in a direction that opposes the direction of air flow generated by the hammer mill for improved operation. Otherwise, some of the material being dried may be blown out the initial input opening and/or other openings of the dryer and into the environment due to pressure generated by operation of the hammer mill.

In addition to a fan or blower, the blower system may further include one or more air lock(s) and/or a cyclone for capturing and collecting dust or particles from the air/gas blown or pulled out of the auger tube(s) to keep them from being blown into the environment. Such dust or particles from the auger tube(s) may also be recirculated back to rejoin the rest of the dried biomass or organic material exiting the system. Accordingly, the blower system may be a closed loop system with any dust or particles exiting the blower being recovered into the bulk flow of biomass or organic material. According to some embodiments, the blower may pull air directly from the last auger tube in the series, which would in turn pull air from the interior of the other auger tube(s) and ultimately from an initial input opening of the tube(s). The air exiting the blower may be circulated into a cyclone. The cyclonic flow of air and particles from the blower inside the cyclone causes the dust and particles to settle to the bottom of the cyclone where it can fall into an air lock for return with the bulk flow of dried material exiting the system. The air inside the cyclone may ultimately flow out a top exhaust opening of the cyclone. A person skilled in the art would understand that a cyclone is a device for capturing and separating dust and other particles from a flow of gas/air.

Unlike the air being pulled through the blower, the bulk dried material may exit a final output opening of the last (or only) auger tube in the series. Such dried material exiting the final output opening of the only or last auger tube in the series may optionally enter an input opening (or end) of an incline or discharge auger to carry the dried material to a more manageable height, such that there is room underneath the output opening or end of the incline auger for the dried material exiting the inclined auger to be captured or dropped into a bag, bin, container, etc. A small enclosed space may be present between the output end of the auger tube(s) to receive the material from the only or last auger tube in the series and the incline auger. Such a small enclosed space may be considered part of the incline auger. The incline or discharge auger may have a diameter of about 5-6 inches, although a range of other diameters are also possible. To force the air or gas flow generated by the fan or blower to flow through the auger tube(s) (instead of another path of less resistance), one or more air lock(s) may be positioned at various exit or output opening(s) of the auger tube and/or incline auger. The air lock may function by blocking any direct flow of air from one side of the air lock to the other due to rotating fins that contact the interior walls of the air lock (e.g., like a rotary entrance/exit door on a building). An air lock may also be placed between the cyclone and where the dust or particles captured by the cyclone reenter the bulk flow of dried material, such as into the incline or discharge auger. However, particles or dust captured by a cyclone may alternatively be returned to an auger tube.

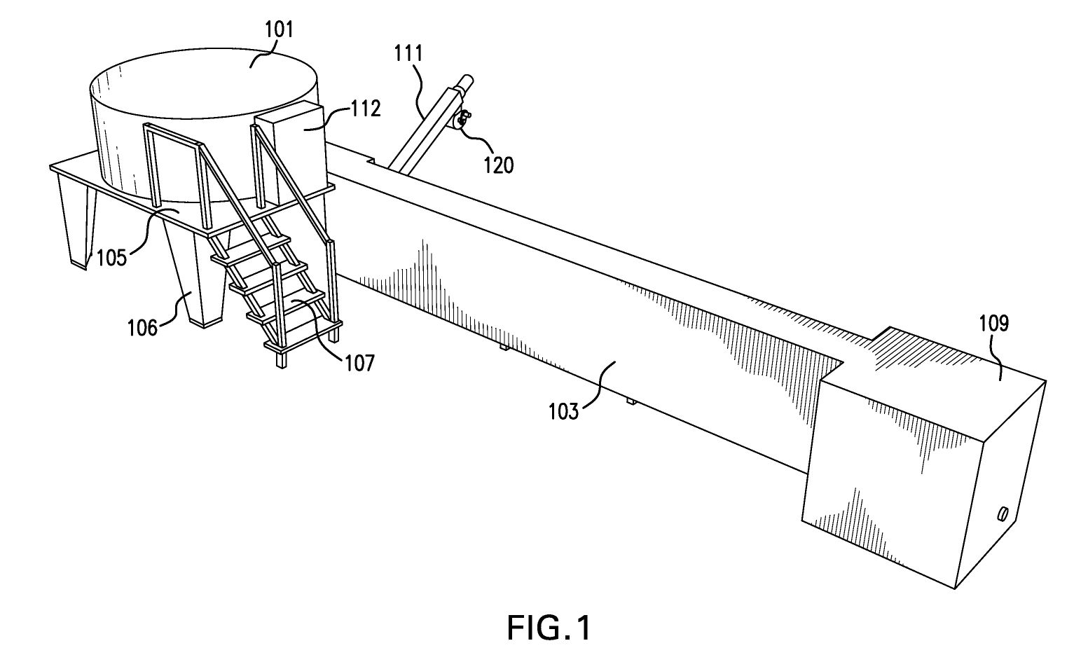

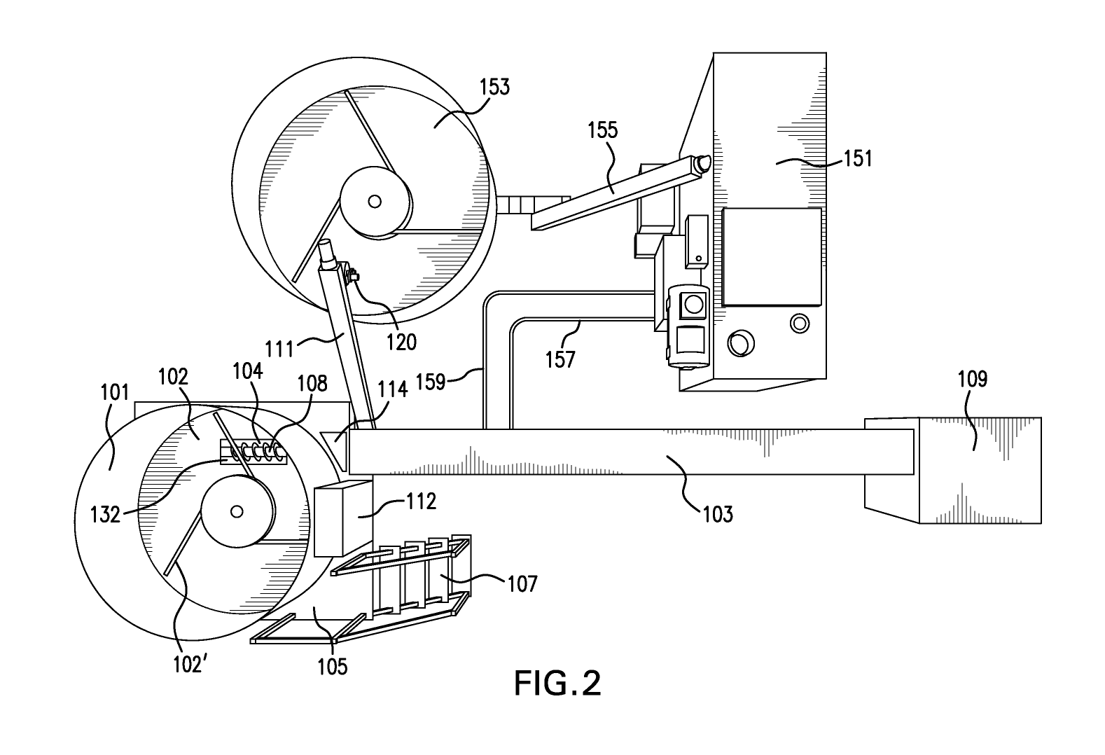

FIGS. 1 and 2 provide an external view of a simplified embodiment of a drying apparatus of the present invention. A first hopper or bin 101 is shown near a proximal end of the auger tube stack 103 (shown enclosed by paneling in FIGS. 1 and 2), the hopper or bin 101 being used for holding and storing a biomass or organic material. A box, enclosure, etc., 112 may be present at a convenient location and height for access by a user, such as on the side of the bin 101, for housing electronic processing controls and a user interface, display and/or control panel. To have the biomass or organic material in the first bin 101 elevated high enough off the ground for the material to enter into a proximal end of a first upper auger tube, or an extended proximal tube or portion, the bin 101 may be elevated and/or placed on top of a platform 105 or other support structure, which may have an elevated, horizontal surface supported by legs 106. Such a platform 105 or other structure may have a stairwell 107 for a user to access the top of it and observe and/or interact with the interior of the bin 101.

The material inside the bin 101 may enter a proximal end of the first upper auger tube, or an extended proximal portion or tube, by gravity through an initial input opening 104 (see, e.g., FIG. 2). The initial input opening 104 may be formed in and through the platform 105 and/or a floor 102 of the bin 101. However, such a platform 105 may not be present where the proximal end of the first upper auger tube, or the extended proximal portion or tube, is present (i.e., it may extend or wrap around the first upper auger tube or the extended proximal portion or tube). At the distal end of the enclosed auger tube stack 103, an enclosed hammer mill 109 is shown for receiving at least partially dried biomass or organic material from the top auger tube(s) (not visible) of the auger tube stack 103. The enclosed hammer mill 109 may break up the material into smaller pieces for further drying and movement proximally through a lower auger tube(s) (not visible) in the stack 103. Bulk flow of dried material may then exit a final output opening of the auger tube(s) at or near the proximal end of the lower auger tube(s) of the stack 103, and the dried material may then enter an incline or discharge auger 111 for lifting the dried material to a more useable or attainable height, which may exit a distal or elevated end of the incline or discharge auger 111 through an air lock 120.

Although not shown in these figures, a second hammer mill may also be placed under the elevated output end of the incline auger 111 for receiving the dried material exiting the output of the incline auger 111. Thus, the dried material may be further broken down and/or pulverized by the second hammer mill into smaller or finer particles or pieces. A second incline auger (e.g., a discharge or auxiliary auger) may also be present for receiving the dried material from the second hammer mill through is input end and moving such material to a more elevated output end of the second incline auger at a more useable height. The second incline auger may also receive the material from the second hammer mill through a discharge air lock. As introduced above, various sensors may also be present to measure the amount, level, presence and/or absence of material in a bin, tube, etc., as well as possibly the presence of material at an exit or output opening of au auger tube, air lock, etc.

According to some embodiments, the dryer apparatus of the present invention may also be optionally paired with a burner unit system, with (i) the burner unit supplying hot water to the dryer apparatus, and/or (ii) the dryer apparatus supplying dried biomass fuel to the burner unit. A top view of a drying apparatus of the present invention with a stacked set of auger tubes (similar to the dryer embodiment in FIG. 1) is shown in FIG. 2 together with a burner unit 151. As stated above for the dryer, a wet biomass or organic material may be stored in a first bin 101 and enter the auger tube stack 103 through an initial input opening 104 in the floor 102 of the bin 101. A stir bar(s) or agitator(s) 102′ may be present near the floor 102 of the bin 101 to move, more evenly distribute and deliver the material inside the bin to the initial input opening 104.

The material (to be dried) that enters the auger tube(s) through the initial input opening may then advance distally through an upper auger tube of the auger stack 103 (by action of an upper auger(s)) and then return proximally in a reverse direction through a lower auger tube of the stack 103 (by action of a lower auger(s)) toward the bin 101. At the distal end of the auger tube stack 103, the material may also fall through a hammer mill 109 (shown enclosed in FIGS. 1 and 2) to help break up the material into smaller pieces. After passing through the auger stack 103 and hammer mill 109, the dried material may then exit through a final output (or exit) opening (not visible) from the last auger tube (e.g., a lower auger tube) of the auger stack 103. The final output opening may be present in and through a bottom side of the last (lower) auger tube in the stack 103 at or near a proximal end of the stack 103, such that the material may fall through the final exit or output opening by gravity. The material exiting the final output opening of the auger stack may then enter an input opening of an optional incline auger 111, advance upward inside the incline auger 111, and fall out an exit or output opening near the top or inclined end of the incline auger 111, perhaps through an air lock 120, for use in a subsequent process. The exit opening may be on the underside of the incline auger 111 such that the material may fall through the exit opening of the incline auger 111 by gravity. Finally, the dried material exiting the exit opening of the incline auger 111 and/or the airlock 120 may then fall into another container, bag, bin, etc., for storage and/or subsequent use.

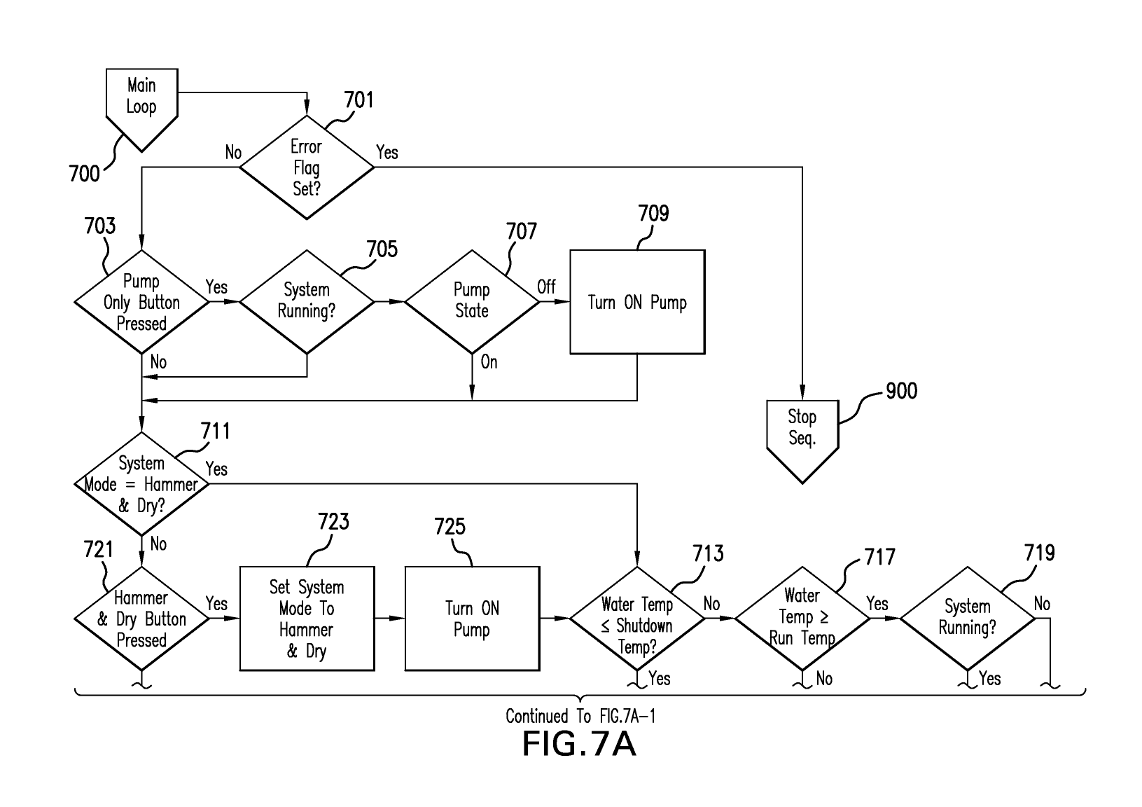

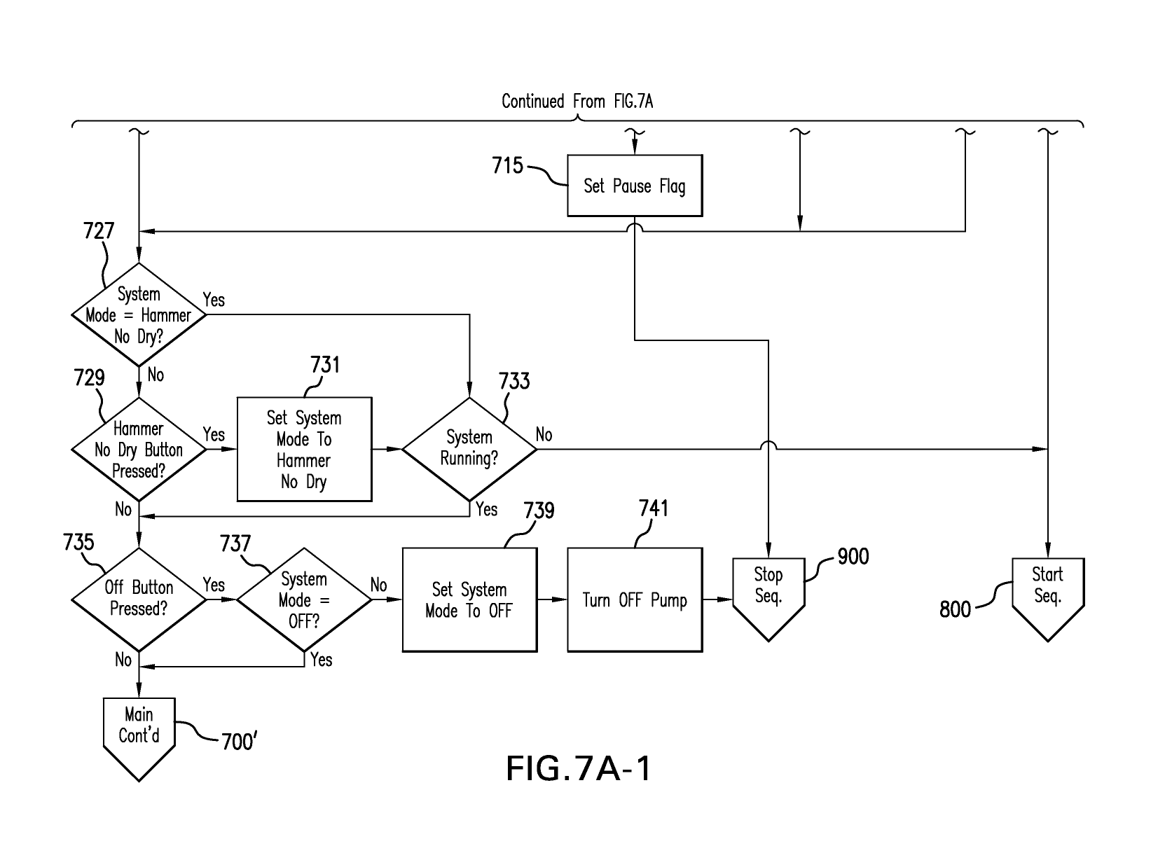

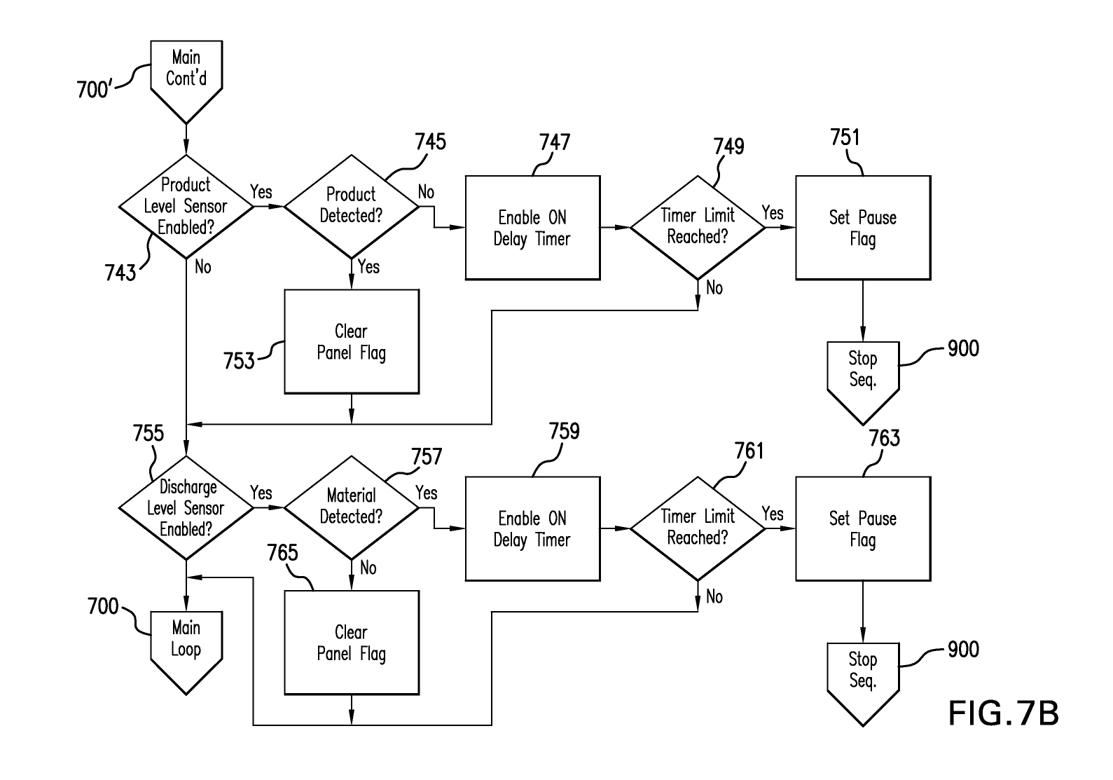

A sensor may be present to detect the level as well as any backup in the flow of material in any one or more of the auger tube(s) or other component of a dryer apparatus of the present invention. One or more sensor(s) may also be present to determine the amount or presence/absence of material in a hopper, bin, etc., and then cause the dryer to modify its operation accordingly. For example, an access door or safety gate may be present at a location between the interior of an auger tube and the exterior environment. One embodiment for such an access door or safety gate 114 is shown in FIG. 2. If the material backs up near such an access door or safety gate 114 and causes it to open due to pressure or piling up of the material inside the enclosed auger tube, the opening of the access door or safety gate 114 may trigger the dryer apparatus to change its operational parameters and/or cause it to stop or shutdown (especially after an interval of time). As discussed below in reference to the flowcharts in FIGS. 7-10, the opening of a safety gate or the like may cause an error flag to be set that may affect the operation of the dryer and/or cause the operation of the dryer to pause, stop or shutdown.

According to the embodiment shown in FIG. 2, the dried material exiting the exit opening of the incline auger 111 and/or the airlock 120 may fall and be deposited into a second storage bin 153, which may be used to hold the dried material from the dryer apparatus until it is fed into a burner unit 151 via a conveyor 155, which may include a horizontal and/or an incline auger(s). The dried material inside the second bin 153 may be moved, distributed, circulated, etc., and delivered to the conveyor 155 through a conveyor opening 154 in the floor of the second bin 153 The dried material fed into the burner unit 151 from the second bin 153 may be burned, combusted, etc., to generate heat. The heat generated by the burner unit 151 from burning the dried material may then be used to make hot water. The hot water may then flow out of the burner unit and toward the dryer apparatus via a first hose or pipe 157. Such hot water from the burner unit 151 may enter jacket(s) or sleeve(s) surrounding the auger tubes of the auger stack 103 to assist in drying the next batch of biomass or organic material for subsequent use by the burner unit 151. The hot water flowing through the jacket(s) or sleeve(s) of the auger tube(s) of the dryer may then exit the dryer apparatus and circulate back to the burner unit 151 via a second hose or pipe 159. Therefore, with the embodiment shown in FIG. 2, the dryer and burner unit may function together in tandem, wherein at least some of the energy generated by the burner unit is used to assist the dryer apparatus in drying the biomass or organic material for its improved burning, combustion, etc., as a fuel by the burner unit, and so on.

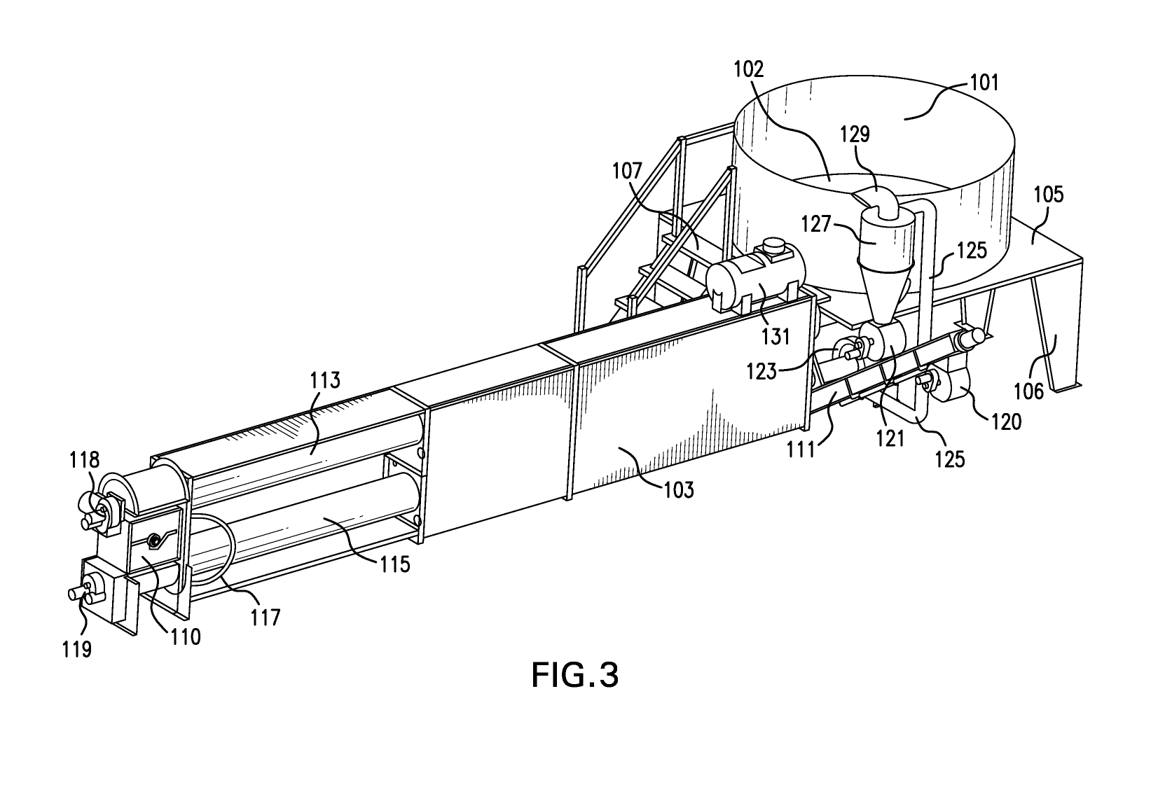

FIG. 3 shows another view of an example embodiment of the present invention similar to FIG. 1 (viewed from the opposite side) with some of the side paneling removed to visualize and reveal the interior of at least a portion of an auger tube stack 103 and hammer mill 109, 110. A first (upper) sleeve or jacket 113 is shown surrounding the upper auger tube(s) in the stack, and a second (lower) sleeve or jacket 115 is shown surrounding the lower auger tube(s) in the stack. Rotation of the auger in the upper auger tube may be driven or powered by a first auger motor 118, and rotation of the auger in the lower auger tube may be driven or powered by a second auger motor 119. For example, the auger motors may each be 90 V DC electric motors; however, other motor types having different power levels are also possible. The hammer mill 110, or a portion thereof, is also shown positioned between the output opening at the distal end of the upper auger tube and the input opening at the distal end of the lower auger tube. A hose 117 is also shown to carry hot water between the sleeve or jacket 113 surrounding the upper auger tube and the sleeve or jacket 115 surrounding the lower auger tube (possibly in either direction). An incline auger 111 is further shown for carrying dried material exiting through a final output opening of the auger tube(s) to a more useable height, such that the dried material may then fall out of the incline auger (through its output opening) into the environment (possibly through a first air lock 120).

In the example embodiment shown in FIG. 3, a blower or fan 123 is present (although partially hidden) near the proximal end of the auger tube stack and the final output opening of the lower auger tube (not shown) for pulling air through the auger tube(s). A pipe(s) 125 is also shown for carrying the air pulled out of the auger tube(s) by the blower 123 and directing that air into a cyclone 127 for capturing and separating dust and particles out of the blown air. Dust and particles captured and separated out of the blown air by the cyclone may then be directed back into the incline auger 111 through a second air lock 121. With the particles and dust separated from the air (by the air flow inside the cyclone 127), the air may then flow out of the cyclone 127 through an exhaust 129 without the particles and dust being blown out into the environment. A container 131 is further shown that may be optionally used for adding substances, such as glycerin (see below) to the material being dried.

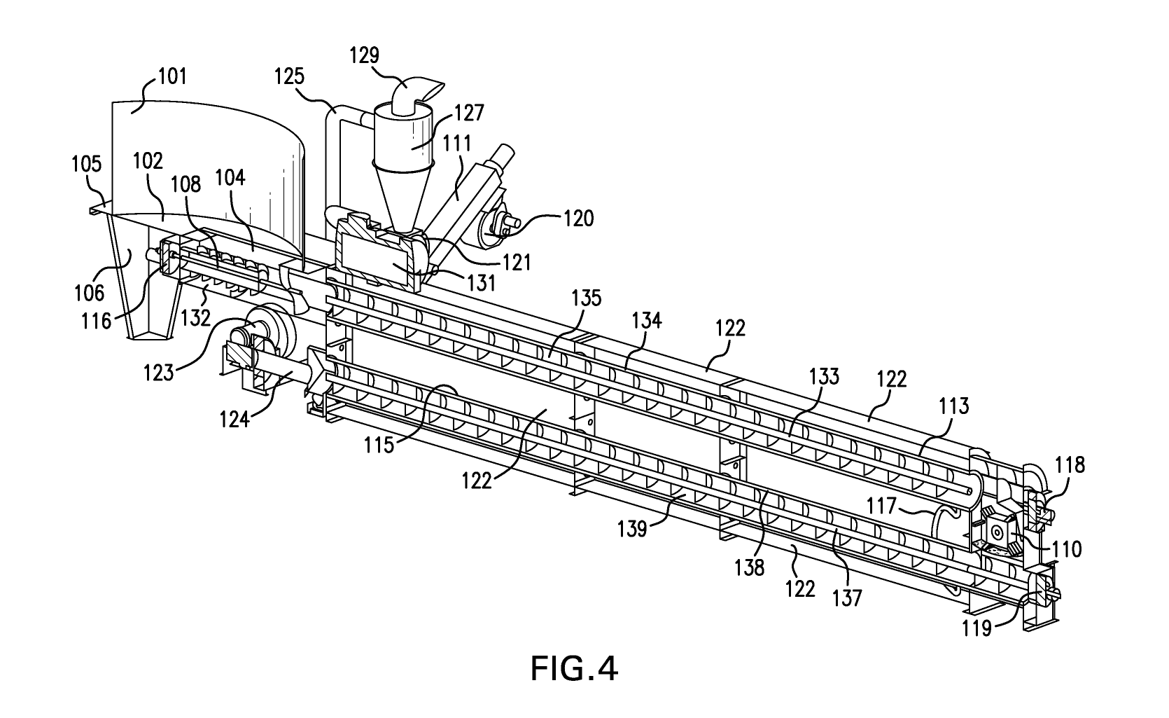

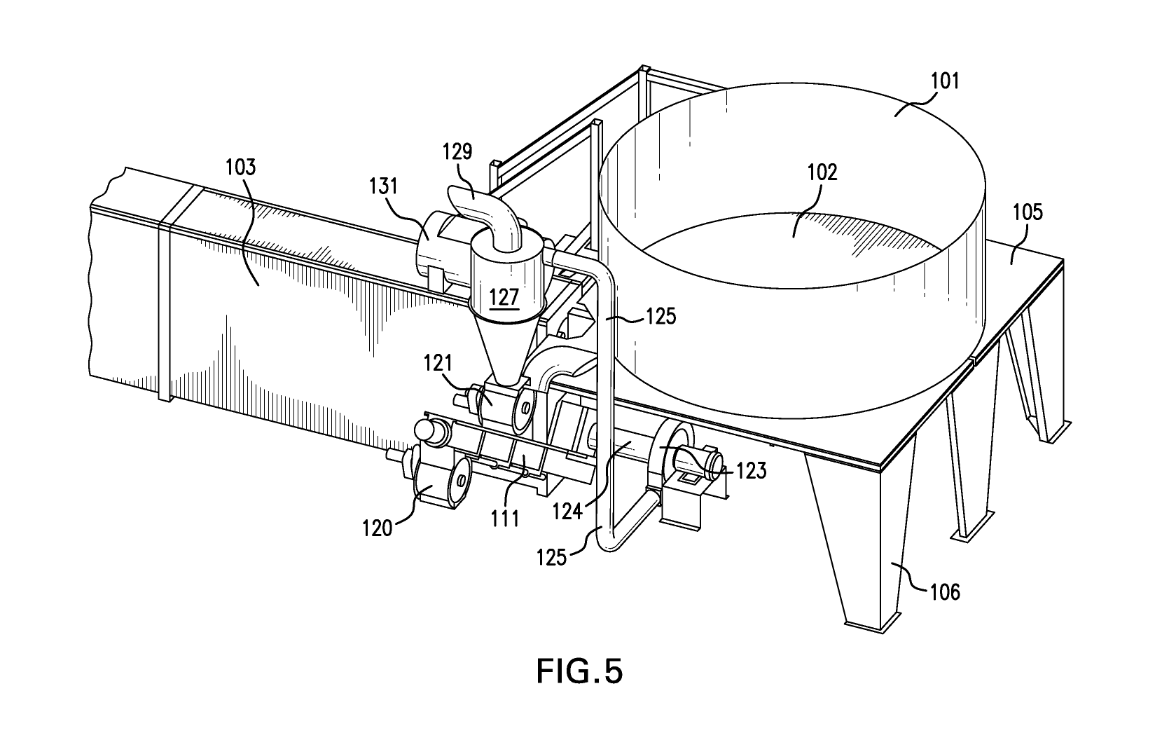

FIGS. 4 and 5 provide additional views of a blower and air lock system of the present invention as also shown in FIG. 3. An extended blower tube 124 is further visible in these figures that is in fluid communication with the lower auger tube 139 and the blower 123, such that the blower 123 is able to pull air from the lower auger tube 139, and in turn from the hammer mill 110, upper auger tube 135, and ultimately from the external environment of the dryer, such as through an initial input opening 104. As can be more clearly seen in FIG. 5, air pulled out of the auger tubes by the fan or blower 123 may be channeled to the cyclone 127 via a pipe 125. The air inside the pipe 125 may be blown into the interior of the cyclone 127 tangentially toward, along, near, closer to, etc., an internal side surface of the cyclone 127 to help encourage a cyclonic flow of the blown air inside the cyclone. Due to the cyclonic flow of the air inside the cyclone, the heavier particulate matter falls out and settles on the bottom of the cyclone 127, while the circulating air (with the particles and dust largely removed) flowing out through an exhaust opening 129 of the cyclone 127. The particulate matter that settles at or near the bottom of the cyclone may then fall by gravity into an air lock 121 to rejoin the bulk flow of dried material, such as inside the incline auger 111.

The example embodiment in FIG. 4 further shows a cross-sectional view of the interior of the auger tubes with the augers present inside them. The spaces or spacings between the jackets/sleeves and the respective auger tubes (i.e., the jacket/sleeve spaces) are also shown. As mentioned above, the blower 123 may be positioned near a proximal end of the lower auger tube 139 for pulling air from within the lower auger tube 139 via an extended blower tube 124 continuous with the lower auger tube 139. An upper auger 133 is shown positioned inside the upper auger tube 135, and the upper auger tube 135 is shown inside (i.e., positioned concentrically within) an upper sleeve/jacket 113. A lower auger 137 is also shown positioned inside the lower auger tube 139 with the lower auger tube 139 positioned inside (i.e., concentrically within) a lower sleeve/jacket 115.

As further observable from FIG. 4, the material inside the bin 101 is able to fall into an extended proximal portion of the upper auger tube 135 through an initial input opening 104 in the floor 102 of the bin 101. The initial input opening 104 in the floor of the bin is shown continuous with a top input opening of the upper auger tube 135, which may be designated jointly as 104 in FIGS. 2 and 4. Many of the additional components including the blower and air lock system 121, 123, 125, 127, 129, the incline auger 111 as well as other components including the auger motors 118, 119, etc., described above in reference to FIGS. 1-3 are again shown in FIG. 4. The first or upper auger motor 118 causes rotation of the upper auger 133, and the second or lower auger motor 119 causes rotation of the lower auger 137. The distal ends of the shafts of the augers 133, 137 are shown cut away in cross-section for visibility purposes in the figure but may actually extend in a suitable manner (with or without auger fighting) to their respective auger motor 118, 119, such that the motors 118, 119 can impart rotation to their respective augers. Alternatively, an extended shaft(s) may be present between (and physically couple) the distal end(s) of one or both of the auger(s) 133, 137 and their respective auger motor 118, 119. The extended shaft(s) may be part of an upper and/or lower distal extended auger(s) that may be physically coupled to the respective upper and/or lower auger(s) 133, 137, such that rotation of the extended distal auger(s) and shaft(s) may be imparted to the respective upper and/or lower auger(s) 133, 137. Since the material may fall into the hammer mill 110 from the upper auger tube 135 by gravity, the upper auger 133 may be coupled to the upper auger motor 118 by a shaft without fighting. However, the lower auger 137 may be coupled to the lower auger motor 119 by an extended distal auger or portion that has flighting to help draw the material into the lower auger tube 139.

The proximal ends of the shafts of the upper and lower augers 133, 137 are also shown cut away for visibility purposes in the figure but may actually extend further proximally and insert into a corresponding hole, bracket, support, etc., at or near the proximal end of the respective auger tube to help hold the respective auger(s) securely in place and avoid wobbling, vibration, etc., during their operation. Alternatively, however, proximal ends of the shafts of the augers 133, 137 may instead be free, and at least a portion of the augers 133, 137 may rest on the bottom of their respective auger tube.

The interior of the hammer mill 110 is also shown in FIG. 4 for receiving material from the distal output end of the upper auger tube 135, breaking up the material into smaller pieces, and delivering it to the distal input end of the lower auger tube 139. The hammer mill 110 will be discussed further below. An extended distal portion of the lower auger tube 139 (or an extended distal auger tube continuous with the lower auger tube 139) is shown having an extended distal auger, which may be an extended distal portion of the lower auger 137. The extended distal tube (or the extended distal portion of the lower tube 139) is further shown positioned underneath the hammer mill 110 for receiving the material from the hammer mill 110. Again, the extended distal auger inside the extended distal portion of the lower auger tube 139 may be a distal extended portion of the lower auger 137 or a separate auger that is physically coupled at its proximal end to the distal end of the lower auger 137 for their joint rotation as powered by their respective auger motor.

As further shown in FIG. 4, an extended proximal tube 132 is present having an interior space, cavity or lumen (i.e., an interior) that has a shared opening and/or is at least partially continuous with the interior space, cavity or lumen (i.e., the interior) of the upper auger tube 135, such that material entering the extended proximal tube 132 through the initial input opening 104 may flow through the extended proximal tube 132 and enter the upper auger tube 135. As mentioned above, the extended proximal tube 132 may instead be an extended proximal portion of an upper auger tube. An extended proximal auger (or material or product feed auger) 108 is further shown positioned inside the extended proximal tube 132 for causing movement of the material through the extended proximal tube 132 and into the upper auger tube 135. The extended proximal auger 108 may be caused to rotate by a proximal auger motor 116 that may be positioned on the side or end of the extended proximal tube 132 opposite the upper auger tube 135. By having a separate proximal auger motor 116 for rotating the extended proximal auger 108, the rate of rotation of the extended proximal auger 108 may be regulated or controlled independently of the upper auger 133 in the upper auger tube 135. In addition, with the extended proximal auger 108 being separate from the upper auger 133, the pitch of the flighting of the extended proximal auger 108 may be different than the pitch of the flighting of the upper auger 133, such that a given rate of rotation of each auger may advance the material longitudinally at a different rate. Alternatively, an extended proximal auger may not have its own proximal auger motor and may be physically coupled at its distal end to the proximal end of the upper auger.

The distal end of the shaft of the extended proximal auger 108 (i.e., toward the upper auger tube 135) is shown truncated before reaching the distal end of the extended proximal tube 132 and proximal end of the upper auger tube 135 but could extend further distally than shown. In any case, the distal end of the extended proximal auger 108 may be inserted into insert a corresponding hole, bracket, support, etc., at or near the distal end of the extended proximal tube 132 and/or the shaft of the upper auger 135 to help hold the extended proximal auger 108 securely in place and avoid wobbling, vibration, etc., during its operation. Alternatively, the distal end of the shaft of the extended proximal auger may instead be free, and at least a portion of the extended proximal auger may rest on the bottom of the extended proximal tube. Although the extended proximal auger 108 is shown having a shaft with a diameter that is greater than the diameter of the shaft of the upper auger 133, the diameters of the shafts of the extended proximal auger 108 and the upper auger 133 may instead be about the same.

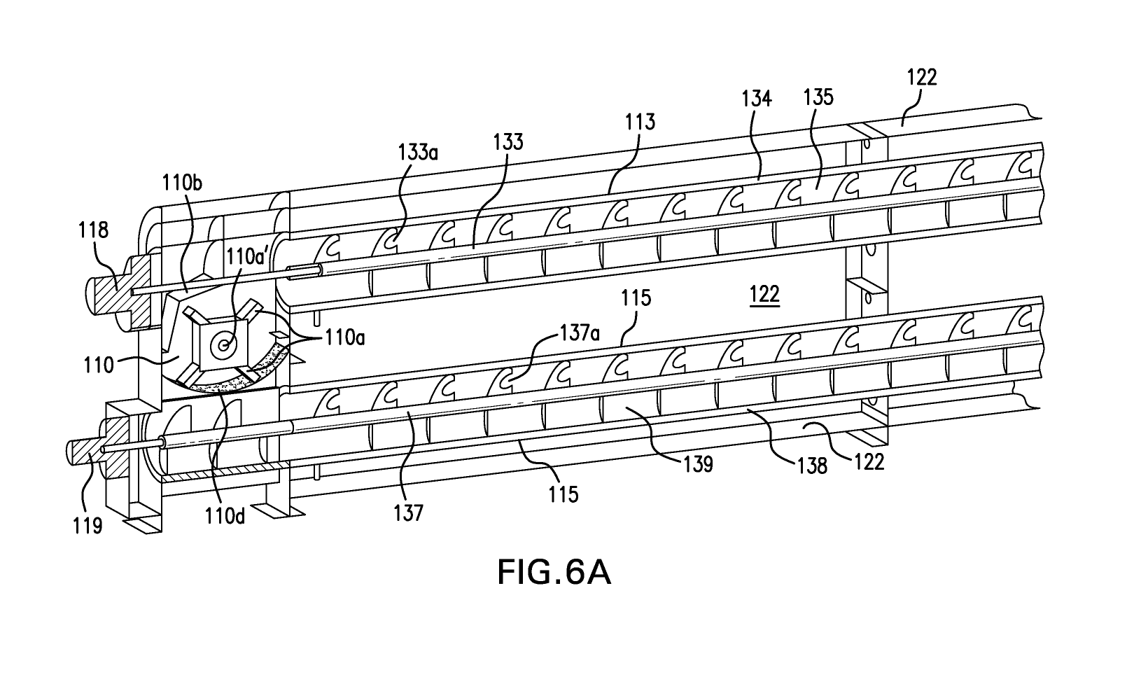

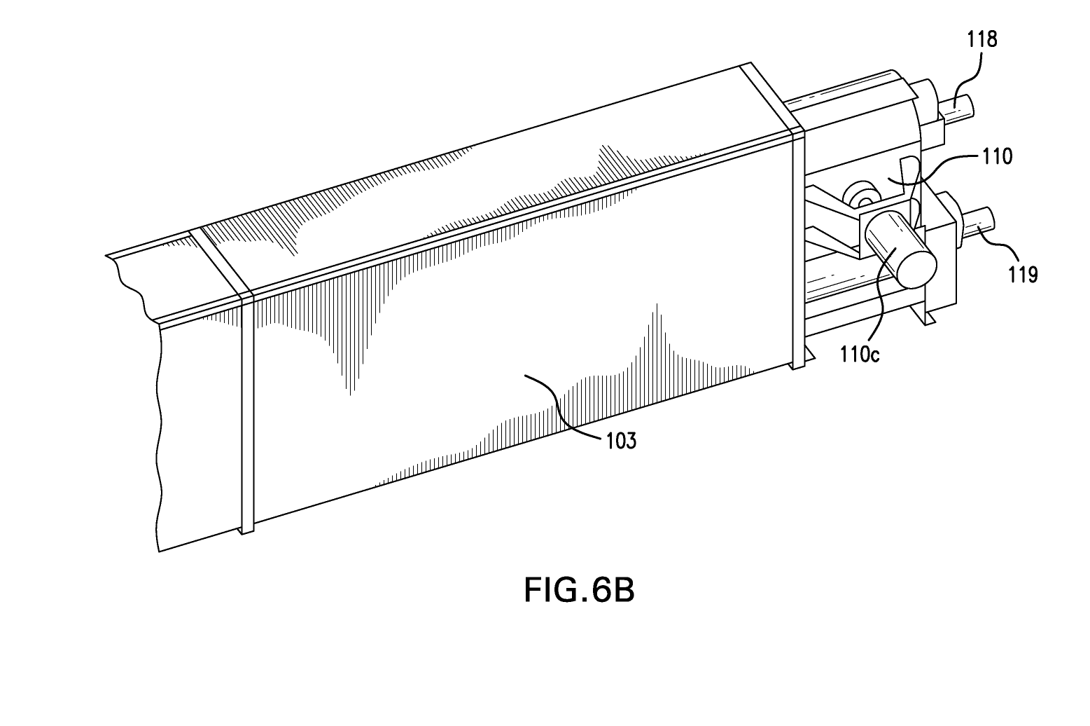

FIG. 6A presents another cross-sectional view of a distal portion of an auger tube stack with a hammer mill 110 at the distal end of the auger tube stack according to an embodiment of the present invention. Upper auger 133 is shown inside upper auger tube 135 (with upper auger tube 135 inside upper jacket/sleeve 113), and lower auger 137 is shown inside lower auger tube 139 (with lower auger tube 139 inside lower jacket/sleeve 115). Each jacket or sleeve may also be referred to as an outer tube or enclosure. An upper jacket space 134 is shown between the upper jacket/sleeve 113 and the upper auger tube 135, and a lower jacket space 138 is shown between the lower jacket/sleeve 115 and the lower auger tube 139. As an additional optional feature, a plurality of holes 133a are shown in and through upper auger 133 for allowing flow of air/gas through them, and a plurality of holes 137a are also shown in and through lower auger 137 for allowing flow of air/gas through them.

According to the example embodiment in FIG. 6A, a plurality of hammers 110a are shown as part of hammer mill 110 that are oriented radially and attached to a center or pivot 110a′ defining an axis of rotation. Baffling 110b is also shown inside hammer mill to define the interior space of the hammer mill 110, which may help to direct the flow of material through the hammer mill 110. A screen 110d is also shown that the outer radial ends of the hammers 110a closely pass during rotation of the hammers 110a around the center 110a′ and axis of rotation. Thus, material exiting the distal end of the upper auger tube 135 enters the hammer mill 110 from the top and falls by gravity through the hammer mill 110 toward the screen 110d. Due to the rotation of the hammers 110a around the center 110a′, the material becomes broken down by the forceful action of the hammers 110a, especially between the outer radial ends or edges of the hammers 110a and the screen 110d. After passing through the hammer mill, the material falls into the distal end of the lower auger tube 139 beneath the hammer mill 110. FIG. 6B shows another view of a distal portion of the auger tube stack 103 and hammer mill 110 from the other side. A hammer mill motor 110c is also shown for causing rotation of the radial hammers.

According to another broad aspect of the present invention, additional ingredients, additives, substances, etc., may be added to a material to be dried by a drying apparatus of the present invention to impart or give additional properties, qualities, advantages and/or benefits to the material. These additional additives, etc., may be added to, and/or mixed with, the material to be dried prior to the material being placed in the present drying machine or hopper, bin, etc., while the material is inside the bin, etc., or inside the dryer machine itself, such as in one of the auger tube(s). According to some embodiments, such an additive, etc., may be added or dispensed from a container or the like (e.g., container 131 above) having the additive, etc., therein. As one particular example, an amount or volume of glycerine (or glycerin or glycerol) may be added to the biomass or organic material to be dried in conjunction with the present invention. Glycerine is a byproduct of many processing reactions, such as those used to generate biofuels from biological sources. As a result, glycerine is currently in oversupply due to its high rate of production without a matching rate of use or consumption. It is presently proposed that an amount or volume of glycerine may be added to a batch of biomass or organic material, such as to the material in the bin and/or to the material traveling down or entering one or more of the auger tube(s). The glycerine may become well mixed with the material being dried due to the material being churned with the glycerine by the movement of the augers in combination with the heating from the hot water in the jacket/sleeve surrounding the auger tube(s). The hammer mill may also help with mixing and homogenizing the distribution of the glycerine with the material by their forceful mechanical action and/or by breaking up the material into smaller pieces. As a result, the added glycerine may become more evenly distributed throughout, and/or coated onto, the material being dried. Other additives are also envisioned. Basically, any additive that may improve the desired characteristics or properties of a material after drying (e.g., more hygroscopic, increased density, more flammable, greater Btu density, etc.) may be used. For example, vegetable oils, such as palm oil, etc., may be used as an additive.

The addition of glycerine to a biomass material in conjunction with the present drying process causes the dried material to acquire a number of favorable properties. First, since glycerine is a flammable substance, it can augment the burning properties of a dried biomass or organic material. Stated differently, the presence of glycerine with the material may increase its British thermal unit (Btu) density when used as a fuel, thus providing greater heat output per volume of material during its combustion or burning. Indeed, it has been found that the addition of glycerine to a biomaterial can improve its burning (in a subsequent burning or combustion process) while reducing buildup of byproducts on the interior surfaces of a burner unit (that is used to burn the biomaterial) due to the material being more completely burned in the presence of glycerine. Second, the presence of glycerine may also reduce the amount of toxic byproducts generated by burning of some types of substances including certain kinds of animal manure, due to their improved burning. Third, addition of glycerine to a biomass material may also increase the density of a material. This increase in density may help to avoid the material becoming blown around or suspended in the air or environment (i.e., for dust control). Fourth, combining glycerine with a material may make the material more hygroscopic once dried. Indeed, it has been shown that combining glycerine with a biomaterial can cause that material to be able to absorb and hold a greater amount and volume of liquid. It is therefore proposed that glycerine may be added to a biomass or organic material (being dried by a present drying apparatus)—either before or during the drying process, such as to produce a dried glycerine-coated material or product. Such a dried glycerine-coated material or product (made thereby) may thus be more hygroscopic and/or have improved burn characteristics for its disposal and/or use as a fuel. According to one embodiment, it is proposed that a glycerine coated biomaterial may be used as animal bedding to effectively absorb liquids and waste products produced by the animals. Such animal bedding may then be discarded and used as a fuel to generate heat by optionally adding the used animal bedding to a burner unit for its burning or combustion.

According to another broad aspect of the present invention, methods are provided for assembling and operating a dryer apparatus of the present invention. Such methods of operation generally include methods for drying a biomass or organic material(s) according to procedures described herein with or without addition of other additive(s) and/or material(s) before, during and/or after the drying process. Such methods for drying a material may generally include introducing or having a material enter an initial input opening of a first auger tube in a series of auger tubes (or the only auger tube), or an extended proximal tube or portion, of a dryer apparatus (e.g., through or via an initial input opening) and then having the material move, travel, etc., through the interior(s) of the one or more auger tube(s) until it reaches and exits a final output opening of the one or more auger tube(s). The movement of the material lengthwise through the one or more auger tube(s) is generally driven by powered rotation one or more auger(s) present inside (i.e., within the interior of) the auger tube(s). Such a method may further include causing a movement or flow of air or gas through the auger tube(s) by a fan or blower in fluid communication with the auger tube(s). The fan or blower may be present at or near the final output opening of the auger tube(s) and pull air or gas through the auger tube(s) and ultimately from the initial input opening.

According to embodiments of the present invention, methods of operation of a dryer apparatus may further include methods for coordinating, controlling, regulating, etc., one or more variables or parameters of operation of a dryer apparatus in response to user input(s) and/or one or more measured parameter(s). For example, such control methods may include regulating the speed of a fan or blower (i.e., to an adjusted speed to change the rate at which air or gas flows through the auger tube(s)) in response to measurement(s) of the temperature of the air exiting the auger tube(s) or the temperature of the water or liquid exiting the jacket(s)/sleeve(s) of the dryer apparatus (see below). As another example, the rate at which a biomass or organic material is delivered to the auger tube(s) and/or advanced by the auger tube(s) themselves and/or outputted by the incline auger may also be regulated or controlled in response to various measurement(s). According to yet another broad aspect of the present invention, a dried biomass or organic material produced by an apparatus and/or method of present invention is further provided with or without other material(s) and/or additive(s).

Thus, methods of the present invention may include sequences or algorithms for turning ON and/or shutting down (turning OFF) the various components of the apparatus, including the auger motors, incline motor, hammer mill, motorized rotation of stir bars in bin, etc., or regulating or controlling their rate, speed or temperature of operation in an orderly manner and/or in response to various conditions or process variables or parameters that may be measured and/or monitored. These methods and algorithms may also be monitored and controlled by a computer or other logic controller. The apparatus may further have any suitable user interface for a user to enter settings, limits and other operating parameters (e.g., via a touchscreen, etc.) as well as to view various displays, warnings, measurements, etc.

FIGS. 7-10 provide a set of possible algorithm and method embodiments for controlling the operation of a drying apparatus of the present invention. Such control methods may be carried out and/or executed by a computer, controller, processor, circuitry, etc. (collectively a “computer”), as described below. According to many method embodiments, such a drying apparatus may be similar to the drying apparatus described above in reference to FIGS. 1-7. However, one or more of the method step(s) involving optional components and features may itself/themselves be optional. Likewise, additional and/or a different order(s) of steps may also be possible that deviate from the method embodiments in FIGS. 7-10 according to embodiments of the present invention. At a minimum, a dryer apparatus will generally have at least one auger tube with auger, a pump and jacketed sleeve around the at least one auger tube for carrying hot water, and a fan or blower for causing air flow through the interior of the auger tube(s). Not only may method step(s) described below not be carried out or performed by a dryer apparatus of the present invention, method step(s) involving other optional components and features not shown or described in reference to FIGS. 7-10, such as for additional auger tube(s), hammer mill(s), incline and/or discharge auger(s), etc., may also be included according to method embodiments of the present invention. One skilled in the art would understand how to incorporate any such additional method step(s) of the present invention based on the description herein of similar component(s) and/or method step(s).

Various different parameters can be measured and/or controlled according to embodiments of the present invention. In fact, one or more measured parameters may be used or taken into account to determine how to vary, adjust, control, etc., the operation of another controlled parameter (e.g., the operation of one or more dryer component(s), etc.). Such method(s) for controlling the operation of a dryer apparatus of the present invention may include step(s) for turning it/them ON or OFF, and/or controlling, adjusting, etc., its/their target speed, temperature, etc., during operation. Examples of operational parameters that may conceivably be measured include: (i) the temperature of water exiting an a jacketed space around an auger tube and/or exiting the dryer apparatus; (ii) the temperature of air or gas exiting an auger tube and/or the dryer apparatus (e.g., at or near a blower or fan pulling the air or gas from the auger tube(s)); and (iii) the moisture content or humidity of the air or gas exiting an auger tube and/or the dryer apparatus. On the other hand, examples of parameters that may conceivably be varied or controlled (in terms of being turned on/off and/or controlling their temperature, speed, etc., of operation) include: (i) the speed of rotation of the auger(s) inside the auger tube(s)—i.e., to determine the “dwell time” and rate at which the material is moved or advanced longitudinally through the auger tube(s); (ii) the speed of rotation of the extended proximal auger (perhaps in conjunction with an agitator inside a hopper, bin, etc.)—i.e., to determine the “feed rate” at which the material (or load) is being fed into the auger tube(s) of the dryer machine; (iii) the speed of operation of the fan or blower—i.e., to determine the flow rate of air or gas pulled or pushed through the auger tube(s); (iv) the pump for circulating water through jacketed space; (v) the operation of the hammer mill(s) for breaking up the material into smaller pieces; (vi) the operation of auxiliary, discharge and/or incline auger(s) for transporting the material; and (vii) the operation of various air lock(s).

According to an embodiment of the present invention, a main operational loop 700 is shown in FIGS. 7A and 7B as a method, process, algorithm, etc. The steps of the main loop 700 may be conducted by a computer, etc. (collectively a “computer”), as described below. The main operational loop 700 may generally cycle very quickly and repeatedly during the operation of the machine. For example, each pass through the main loop 700 may occur over a time course of milliseconds (e.g., about every 50 milliseconds). Beginning with FIG. 7A, the main loop 700 may begin with determining the selected state or mode of the machine (e.g., as selected by a user) and then proceed with a decision and/or action step(s) accordingly. These alternate modes or states may include: (i) Pump Only, (ii) Hammer and Dry, (iii) Hammer No Dry, and (iv) System Off. The Pump Only mode or setting may cause the hot water pump to run, but without the augers, hammer mill, etc., running. The Hammer and Dry may be full operation mode with the hot water pump and other components including the augers, hammer mill, etc., all running together. On the other hand, the Hammer No Dry mode or setting may be nearly the opposite of the Pump Only mode. In other words, the Hammer No Dry mode may have the hot water pump shut down but all of the other components running. Although the following steps for determining the mode or state of the machine are presented in a particular order according to a main loop embodiment of the present invention, the order of some of the steps may be altered, rearranged, etc., as long as a logical flow of steps is maintained. For example, the order in which it is individually determined if the different system modes or states are set (and the resulting action steps) may generally be rearranged.

According to methods of operation of a dryer apparatus of the present invention, various safety checks may be performed to ensure that the dryer does not continue to operate improperly and/or unsafely. In step 701 of FIG. 7A, for example, a dryer computer may determine whether a safety flag has been set. If a safety flag has been set, then the process may bypass the remainder of the main loop 700 and proceed to a Stop sequence 900 (see below). Although not shown in FIG. 7A, in addition to proceeding to a Stop sequence 900, a pump timer may also be started if a safety flag has been set, and a decision step may also be present to determine if the pump timer has expired a preset or user-selected time limit (e.g., 10 minutes). If the pump timer has expired, then an additional step may also be present for turning OFF the pump before proceeding to the Stop sequence 900. On the other hand, if the pump timer has not expired, then the pump will not yet be turned OFF before proceeding to the Stop sequence 900. According to some embodiments, in addition to turning off the pump, an associated burner unit (if present) that supplies the hot water or liquid to the dryer may also receive a call from the dryer to be turned off if the error flag remains set for the set interval or period of time. It also worth noting that according to some embodiments, the pump and/or associated burner unit (if present) may also be turned off by user input or selection.

Returning to FIG. 7A, however, if a safety flag is determined instead in step 701 to not have been set, then the remainder of the main loop 700 may continue by proceeding to step 703. A so-called “safety flag” (or error flag, etc.) may be set if a number of different states, events or conditions have occurred or exist that might affect the proper functioning of the machine and/or safety of those nearby. The term “flag” means a setting, state, etc., that indicates one or more condition(s) are present. Such a “flag” may generally be temporary in that it may be reversed, removed, etc., once the condition itself causing the flag is corrected, cleared, removed, etc. For example, a safety flag may be set if there is a hardware fault, such as an auger motor or blower becoming tripped, etc. (e.g., due to too much mechanical force being required to operate), or in response to a safety relay being triggered or tripped, such as an access door being opened. In the former case, a shutdown or malfunction of at least one of the dryer system components may have occurred. In the latter case, the machine is operating properly, but a user or person nearby may be exposed to a danger or risk from the machine.

Assuming that there are no risks and the system is operating properly, the remainder of the main loop 700 in FIG. 7A may proceed to determine the state or mode of the system and the appropriate action steps accordingly. At step 703, for example, the main loop 700 may determine if a “Pump Only” button, mode or setting is selected, set or pressed. If the “Pump Only” setting, mode, button, etc., is selected, etc., then the method may proceed to step 705 to determine if the dryer system is operating or running (e.g., whether the system is ON or OFF). If the system is running, then the method continues to step 707 to determine if the pump (for circulating the hot water) is turned ON or OFF. If the pump is determined to already be ON in step 707, then the method simply continues with the rest of the main loop 700. If the pump is determined to be OFF in step 707, then the pump is turned ON, and the method then continues with the rest of the main loop 700. Note that when the “Pump Only” button, mode or setting is selected, set or pressed, the Startup sequence for the various other components is not initiated. Although not shown in FIG. 7A, the main loop 700 may further include additional step(s) including a step for determining whether a system mode is set to “Pump Only,” which may occur before step 703. If the system mode is set to Pump Only, then the main loop may proceed to step 705 as described above. However, if the system mode is not set to Pump Only, then the main loop may proceed to step 703 to determine if the Pump Only button or setting is selected, pressed, etc. According to these additional step(s) not shown in FIG. 7A, if the Pump Only button or setting is determined to be selected, pressed, etc., then there may be an additional step to set the system mode to Pump Only before continuing to step 705.

Following step 703 (whether or not the Pump Only sequence involving steps 705-709 is executed), the main loop 700 in FIG. 7A may then continue on to step 711 to determine if the “Hammer and Dry” mode or setting for the system is selected or set. According to step 711, the Hammer and Dry setting will cause the dryer apparatus to be in a full operation mode running each of its components along with the hammer mill at the distal end of the auger stack. If the system is determined to be set to a Hammer and Dry mode in step 711, then the method in FIG. 7A may then proceed to step 713 to determine if the measured water exit temperature (i.e., the temperature of the water exiting (or about to exit) the machine to circulate back to a hot water source) is less than or below (or less than or equal to) a shutdown temperature. The shutdown temperature may be equal to a target water temperature minus a shutdown temperature offset (e.g., 190° F.−5° F.=185° F.). If the water exit temperature is determined in step 713 to be less than or below (or less than or equal to) the shutdown temperature, then the method may then proceed to step 715 to set a pause flag. The pause flag may be relevant to other operations of the present invention including those outside the main loop 700. After setting the pause flag in step 715, then the method may proceed on to the Stop sequence 900 (discussed below).

However, if the water exit temperature is determined in step 713 to not be or less than or below (or less than or equal to) the shutdown temperature (i.e., the water exit temperature is determined to be more or greater than (or greater than or equal to) the shutdown temperature), then the method may proceed on to step 717 to determine if the water exit temperature is more or greater (or more than or equal to) the target water temperature. If the water exit temperature is determined in step 717 to not be more or greater than (or more than or equal to) the target water temperature (i.e., the water exit temperature is determined to be less than—or less than or equal to—the target water temperature), then the main loop 700 may simply exit the Hammer and Dry sequence and continue with the remainder of the main loop 700 by proceeding on to step 727 (discussed below). However, if the water exit temperature is determined in step 717 to be more or greater than—or more than or equal to—the target water temperature (i.e., less than—or less than or equal to—the target water temperature), then the main loop 700 may proceed to step 719 to determine if the system is running. If the system is determined to not be running in step 719, then the main loop 700 may continue on to a Startup sequence 800 (described below). However, if the system is determined to be running in step 719, then the main loop 700 may simply exit the Hammer and Dry sequence and continue with the remainder of the main loop 700 by proceeding on to step 727.

Returning to step 711 in FIG. 7A, if the system mode is determined to not be set to “Hammer and Dry,” then the main loop may continue to step 721 to determine if the Hammer and Dry button or setting is selected or pressed. If the Hammer and Dry button or setting is determined in step 721 to be selected or pressed, then the main loop 700 may proceed to step 723 to set the system mode to “Hammer and Dry” and then to step 725 to turn ON the pump (i.e., for pumping the hot water into and through the jacketed spaces around the auger tube(s) of the dryer). On the other hand, if the Hammer and Dry button or setting is determined in step 721 to not be selected or pressed, then the main loop 700 may simply continue with the remainder of the main loop 700 by proceeding on to step 727.

As mentioned above, the temperature of the hot water circulating through the dryer apparatus is cooled due to heat and energy being consumed during the drying and evaporation process and due to heat and energy being absorbed and carried away by the air flowing through the auger tube as well as by the material being dried. Both the dried material and air circulating through the tubes ultimately gets carried out into the external environment and thus takes the absorbed energy and heat with them. Therefore, a drop in the temperature of the water exiting the dryer (relative to the temperature of the water entering the dryer) is expected and part of normal operation. However, if the temperature drops too much or too low (e.g., below a minimum shutdown temperature), then this may indicate that the system is operating too quickly and/or carrying too much material load inside the auger tube(s). Depending on the kind of dryer, the type and “wetness” of material, the desired moisture content in the dried material, etc., it is important to maintain the hot water temperature above a minimum temperature to make sure that enough heat is delivered to effectively dry the material. If the water exit temperature gets too low, that may indicate that the material is not being adequately dried. Even if the water exit temperature is low but maintained above the minimum shutdown temperature, more adequate or optimized drying of the material may occur if the water exit temperature were at or near the target water temperature or water run temperature. A high water exit temperature is less of a concern because the hot water should only cool once it leaves the heat source. However, for safety reasons, there may also be a maximum shutdown temperature that may trigger a shutdown or Stop sequence for the dryer, perhaps in addition to shutting down and/or modifying the operation of the heat source (e.g., a burner unit) since a higher water temperature may indicate a problem or improper setting originating from the heat source. Even if the water exit temperature is less than any maximum shutdown temperature, if it is above the desired or preset target water temperature, the main loop may check the status of the system to make sure it is running since proper operation of the dryer should cause some drop in water temperature.

Therefore, in cases where the water exit temperature does fall below a minimum shutdown temperature, the operation of the machine may be modified to bring up the water exit temperature at least above the minimum shutdown temperature. Even if the water exit temperature is above the minimum shutdown temperature but below the target temperature or target water temperature, the operation of the machine may still be modified to bring up the water exit temperature closer to the target water temperature. For example, the speed of the main augers and/or the feed rate (e.g., the speed of a feed auger (or extended proximal auger) for delivering material from a hopper, bin, etc.) may be slowed. As another example, the speed of the blower/fan may also be modified. However, it may be difficult to maintain coordinated operation of the dryer apparatus while separately varying, modifying and/or shutting down multiple individual components due to the many different confounding variables involved including: humidity level(s), air temperature(s), water temperature(s), moisture content and water saturation of material, the amount of material, the type of material, etc.

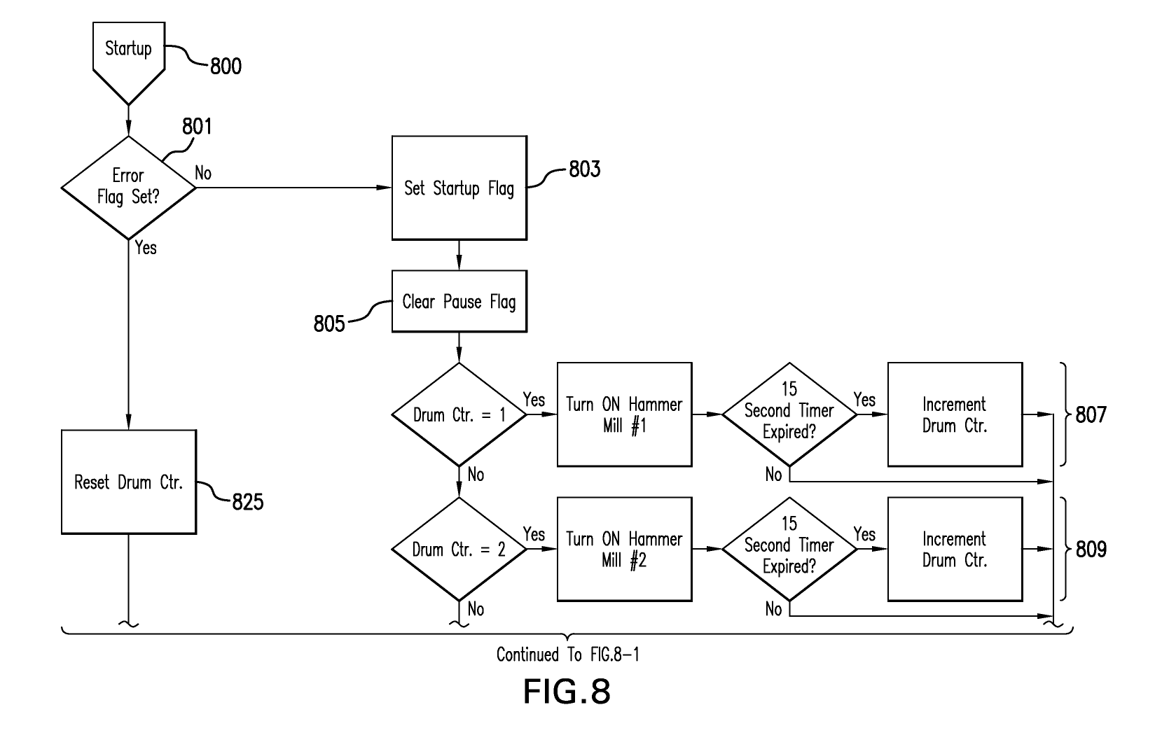

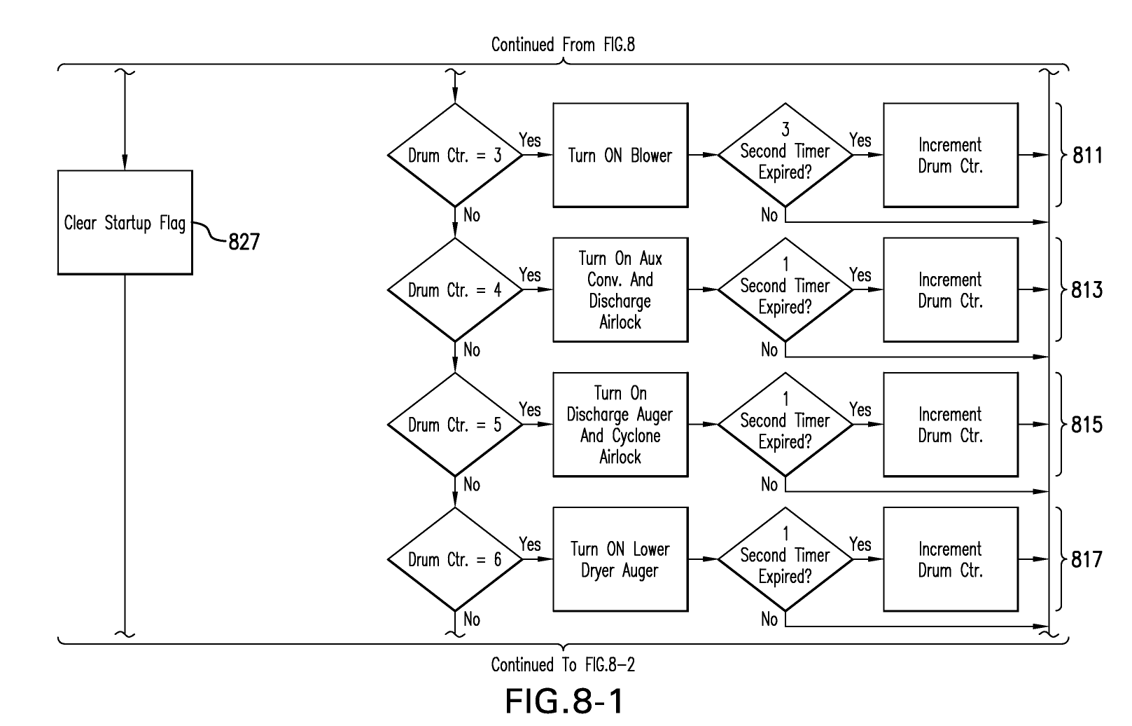

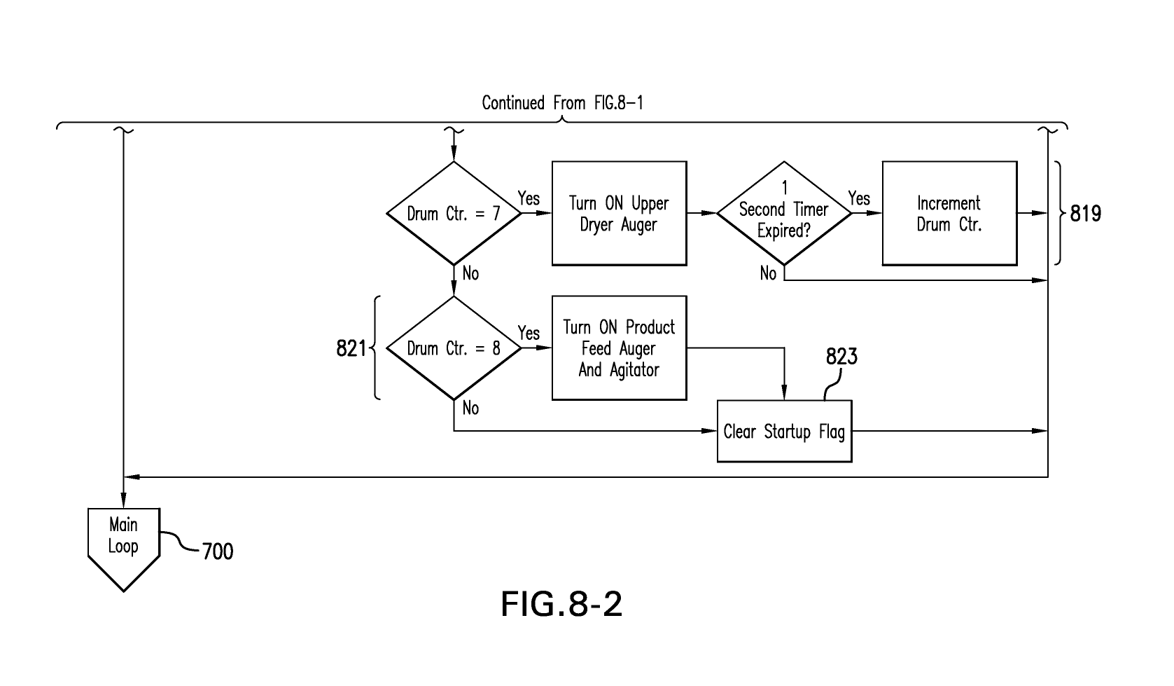

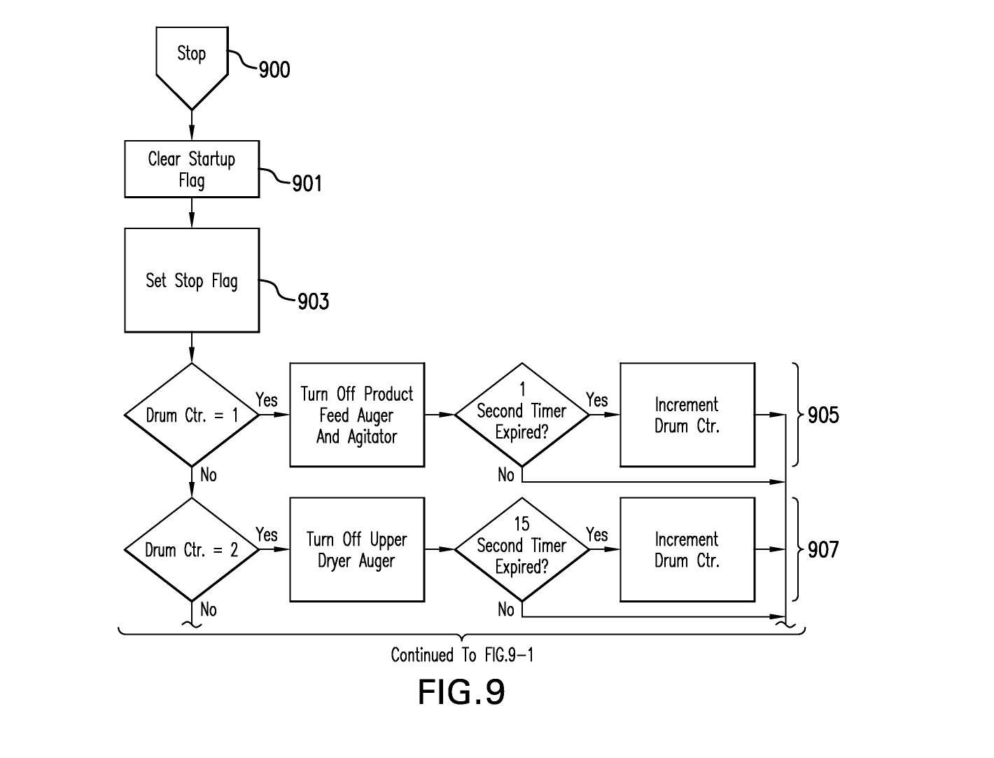

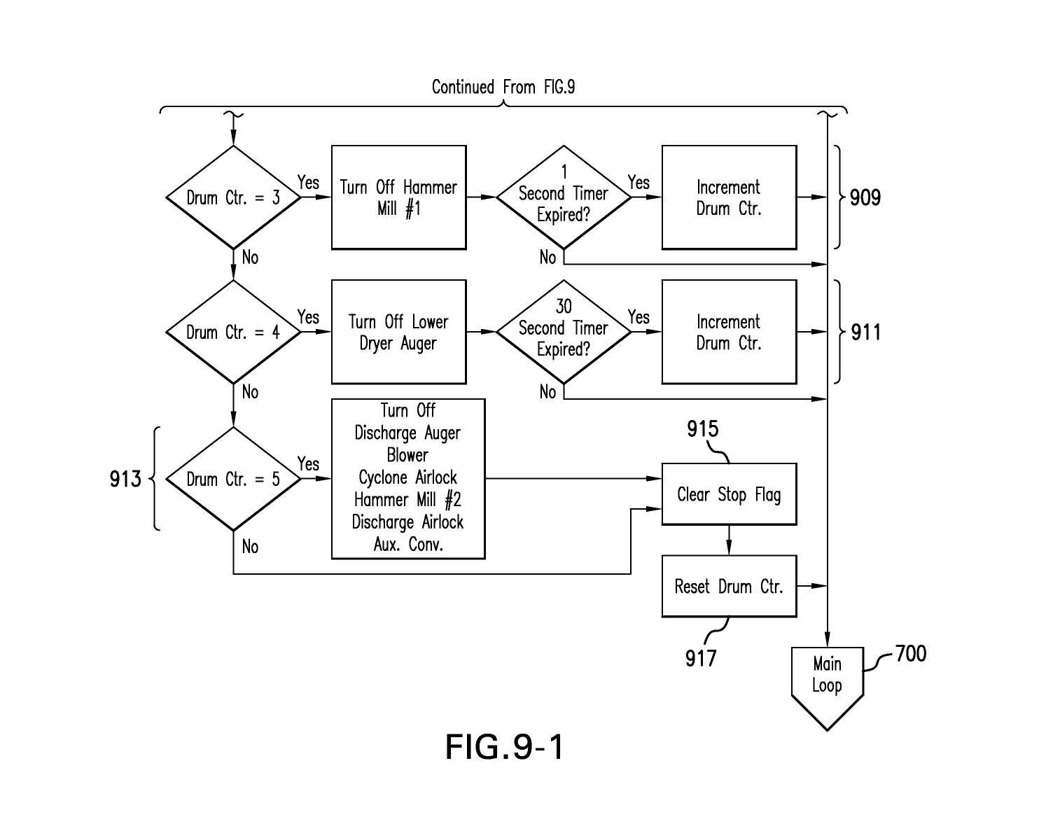

Therefore, it may be preferred for the dryer apparatus to instead vary only one process variable, such as a fan/blower speed, etc., while maintaining the other components operating generally at a constant setting or speed/rate to create more of a continuum of effect(s) in response to varying the single process variable. Such a process variable may be controlled, regulated or adjusted automatically in response to feedback data, such as water exit temperature. By automatically varying only one process variable in response to temperature measurements, such as fan/blower speed, the other components and functions of the dryer may be adjusted manually. Such manual adjustment (e.g., varying the speeds of rotation of the main and/or feed auger(s)) may be used, for example, to increase or decrease overall production rate of dried material with the automatic process control loop responding accordingly to ensure that adequate or desired drying of the material is maintained. As discussed below, a proportional-integral-derivative (PID) controller or other algorithmic calculation or method may be used to determine how to vary the process variable (e.g., fan speed) in response to a measured variable (e.g., water exit temperature) such that the measured variable may remain at or near a desired or present target value or set point (e.g., a target water temperature or water run temperature). To avoid the material in the dryer becoming jammed due to a lack of coordinated operation of the dryer components, each of the components of the dryer machine may be almost entirely shutdown according to a prescribed and coordinated Stop process (instead of turning off only one or some of the components) if the water exit temperature falls below the minimum shutdown temperature. However, the pump(s) circulating the hot water may continue to operate despite the shutdown. Once the water exit temperature is restored to an adequate level, the dryer may then undergo a coordinated Startup sequence to restart the dryer components. Embodiments of a Startup and Stop sequence of the present invention are described below in connection with FIGS. 8 and 9.

Returning to FIG. 7A, after the decision steps to determine if the system mode is set to Hammer and Dry 711 and if the Hammer & Dry button is selected or pressed 721, the main loop 700 may continue (regardless of whether the Hammer and Dry sequence was executed or performed) on to step 727 to determine if the system mode is set to “Hammer No Dry?” If the system mode is determined in step 727 to be set to Hammer No Dry, then the main loop 700 may continue on to step 733 (discussed below). However, if the system mode is determined in step 727 to not be set to Hammer No Dry, then the main loop may continue on to step 729 to determine if the “Hammer No Dry” button or setting is pressed, selected, etc. If the “Hammer No Dry” button is not pressed, etc., then the main loop 700 may continue on to step 735 (see below) and the remainder of the main loop 700. However, if it is determined in step 729 that the “Hammer No Dry” button or setting is pressed, selected, etc., then the main loop 700 may proceed to step 731 to set the system mode to “Hammer No Dry” and then continue on to step 733. At step 733, it is determined if the system is running. If the system is running, then the main loop 700 may continue on to step 735, and if the system is not running, then the main loop 700 may continue on to the Start sequence 800. Thus, unlike the Hammer and Dry setting or mode, the Hammer No Dry setting or mode runs the Startup sequence for processing the material without turning on the pump that circulates the hot water. Without the heat from the hot water, the material may be advanced through the dryer apparatus but perhaps not dried during its passage through the machine due to the absence of added heat and an elevated temperature.

Finally, after the decision steps 727, 729 regarding the Hammer No Dry mode, etc. (regardless of whether the Hammer No Dry sequence was executed), the main loop 700 may continue on to step 735 to determine if the System Off button, setting, etc., is pressed, selected, etc. If the System Off button, etc., is determined in step 735 to be pressed or selected, then the main loop 700 may continue on to step 737 to determine if the system mode is set to Off. If the system mode is determined in step 737 to be set to Off, then the system and method may exit the System Off sequence and continue with the remainder of the main loop 700 (i.e., the continued part 700′ of the main loop in FIG. 7B). If the system mode is determined to be set to Off in step 737, then the Off/Stop Sequence has already been done. Thus, by exiting the Off sequence, repeated attempts at the Stop sequence are avoided. However, if the system mode is determined in step 737 to not set to Off, then the method may continue on to step 739 to set the system mode to Off. After setting the system mode to Off, the method may then proceed on to step 741 to turn off the water pump before continuing on to the Stop sequence 900 (discussed below).

According to method embodiments in FIG. 7A, if the Off button is not selected, pressed, etc., or if the Off button is pressed, etc., but the system mode is already set to Off, then the method may continue on to a remaining portion of the main loop 700′ shown in FIG. 7B. The method steps in FIG. 7B may relate to checking the amount or level of the material or product left in the hopper, bin, etc., that feeds into the dryer, and whether the dried material exiting the machine may have accumulated or piled up (on the ground or inside a second container, hopper, bin, etc.) to a height or level where it may impede or block the exit opening of a discharge or incline auger. Any suitable sensor(s) for detecting the presence/absence of a material and/or a distance to the surface of the material may be used. For example, a first sensor may be placed over the top of the floor of a bin to detect the presence or absence of material inside the bin (e.g., by distinguishing the material from the floor of the bin). A second sensor may also be placed near the exit opening of an incline or discharge auger to detect the presence of the dried material that may have accumulated up to near the exit opening.

According to embodiments of the present invention, these determinations in the continued portion 700′ of the main loop in FIG. 7B may begin at step 743 to determine if a product level sensor is enabled. The product level sensor may be used to detect or determine the presence of material or product inside the bin, etc., for loading into the dryer. If the product level sensor is determined to not be enabled, then the method may continue on to step 755. But, if the product level sensor is enabled, then the method may proceed to step 745 to determine if material or product to be dried is detected inside the bin. If product is not detected inside the bin, then the method may proceed to step 747 to start a product delay timer (if not already started). The method then continues to step 749 to determine if the product delay timer has reached or expired a preset (or user selected) interval of time (or time limit) since being started (e.g., within a range of about 5-30 seconds). If the product delay timer is determined to have expired in step 749, then a pause flag is set in step 751, and the method may continue with the Stop sequence 900. But, if the product delay timer is determined to not have expired in step 749, then a pause flag is not set, and the method continues with the remainder of the main loop by proceeding on to step 755. Returning to step 745, if product or material is detected inside the bin, etc., then any pause flag for the product level in the bin is cleared in step 753, and the method may continue with the remainder of the main loop by proceeding on to step 755. Thus, the product level sensor and sequence is included to check the product level inside a bin, etc., and sets a pause flag and shuts down the system components if any absence of product inside the bin lasts for more than a preset or selected interval of time.

According to embodiments of the present invention, a similar determination may be made at or near an elevated exit opening of an incline or discharge auger, but in this case, the presence (not absence) of material or product may indicate a problem. If the product exiting the machine is piled up too high, it may impede or block new material from exiting the discharge or incline auger. As shown in FIG. 7B, for example, a discharge level sensor and sequence may be included to set a pause flag if material or product exiting the machine is detected at or near the exit opening of the discharge auger. The discharge level sequence may begin at step 755 in FIG. 7B to determine if a discharge level sensor is enabled. If the discharge level sensor is determined to not be enabled in step 755, then the method may return to the top of the main loop 700 in FIG. 7A. But, if the discharge level sensor is enabled, then the method may proceed to step 757 to determine if material or product is detected at or near the exit opening of the incline or discharge auger. If product is detected in step 757, then the method may proceed to step 759 to start a discharge delay timer (if not already started). The method then continues to step 761 to determine if the discharge delay timer has reached or expired a preset (or user selected) interval of time (or time limit) since being started (e.g., within a range of about 5-30 seconds). If the discharge delay timer is determined to have expired in step 761, then a pause flag is set in step 763, and the method may then proceed to the Stop sequence 900. But, if the discharge delay timer is determined to not have expired in step 761, then a pause flag is not set, and the method may proceed to the top of the main loop 700 in FIG. 7A. Returning to step 757, if product or material is not detected at or near the exit opening of the incline or discharge auger, then any pause flag for the discharge level is cleared in step 765, and the method may proceed to the top of the main loop 700 in FIG. 7A. Thus, the discharge level sensor and sequence may be included to check the presence or material or product near an exit opening of a discharge or incline auger, and sets a pause flag and shuts down the system components if any presence of product at or near the discharge opening lasts for more than a preset or selected interval of time.

As described above for the method embodiments in FIGS. 7A and 7B, if the system mode is set to “Hammer and Dry” or “Hammer No Dry” but the system is not running yet (in addition to the right conditions being present to continue), then the main loop may enter a Startup sequence 800 to turn on many of the components of the dryer in an orderly and coordinated manner and sequence. An example embodiment of a Startup sequence 800 is shown in FIG. 8. Similar to step 701 for the main loop 700, the Startup sequence 800 may begin with determining whether an error flag is set at step 801. See discussion above regarding error flag(s)—basically, as error flag may be set if there is a hardware malfunction or shutdown, an access panel or door is open etc., which might affect the proper function of the dryer and/or make it less safe. Thus, if an error flag is determined to be set in step 801, then the actual Startup sequence may be bypassed by resetting a startup drum counter in step 825 and clearing a startup flag at step 827 before returning to the top of the main loop 700 in FIG. 7A. If an error flag is not set, then the Startup sequence in FIG. 8 may continue to set a startup flag at 803 and clear any pause flag at 805 before continuing with the ordered startup of the dryer components using, for example, a startup drum counter sequence.

The startup drum counter sequence is composed of a series of combined startup steps or levels that are similar to each other but work together in sequence to ensure that the components of the dryer are turned on in a desired order with each of the component(s) (after the first components(s)) turning on only after a preset or user selected time delay has expired. Thus, the drum counter ensures that a first component(s) is turned on first, a second component(s) is turned on second after expiration of a first delay timer for the first component(s), a third component(s) is turned on third after expiration of a second delay timer for the second component(s), and so on until all of the components for the Startup sequence have been turned on in the desired order. Therefore, the startup sequence in FIG. 8 utilizing the startup drum counter will be discussed as a series of levels (each comprising a plurality of steps) that may be implemented (one at a time) for a particular component (or set of components) having a common drum count since the internal steps for each level operate basically the same. Although the Startup sequence in FIG. 8 shows the components being turned on in one particular order, it is important to note that other orders or sequences for starting up the dryer components are also possible. Moreover, components that are shown as being turned on together as part of a common drum count may instead be broken out into separate drum count steps.

According to embodiments of the present invention, it may be desirable to turn on the various components in an orderly fashion that avoids jamming of the material inside the machine, which may be caused by pushing the material upstream before downstream components are operating. Thus, downstream actuating components for causing movement of the material or product being dried may generally be turned on sooner during a startup sequence than upstream actuating components. Turning on the dryer components one (or a few) at a time may also avoid any unnecessary power surges that might otherwise occur if most or all of the dryer components to turned on simultaneously. However, several components may be turned on together (e.g., as part of a common drum count) to minimize delay in turning on the machine if simultaneous initiation of those components will not cause any foreseeable problems.

According to the method embodiment of a startup sequence 800 in FIG. 8, a startup drum counter having been reset may have a starting count=“1”. With a count of “1”, the startup drum counter will cause the sequence to proceed with the startup sequence or level 807 for turning on the first component(s), which in this case is shown to be a first hammer mill (i.e., the hammer mill at the distal end of the auger tube stack). The drum counter may operate based on a timer before incrementing the drum counter to the next “level.” The amount of time that may need to expire before incrementing the counter may vary depending on the component being turned on, the type of material being dried, etc., and other settings, but may vary from about 1 second to about 1 minute, or about 1-30 seconds, or any other time interval therein. Indeed, each of the amounts of time provided below for each of the drum counts are only examples and may vary depending on the circumstances. The same may be said for the drum counter and timer(s) used for the Stop sequence 900 described below. Upon a first pass through the first level 807 of the startup sequence, a first delay timer is started. During subsequent passes through the level 807 (due to the counter remaining set at “1”), the startup level 807 for the first component(s) (i.e., for the first hammer mill) checks to see if the first timer has expired (i.e., reached a preset or user selected period of time or time limit for delay), which may be a delay of about 15 seconds, before the next component(s) are turned on. If the period or limit is not reached, then the “Increment Drum Counter” step is bypassed for return to the main loop 700.

However, once the delay time period or limit is reached, the turn on sequence for the first component(s) at the first level 807 advances to increment the startup drum counter (i.e., increment the count from “1” to “2”) before returning to the main loop 700. Thus, on the subsequent pass through the Startup sequence 800 (assuming that the drum counter has not been reset), the actual startup sequence of components will proceed on to the next level 809 to turn on a second component(s) (e.g., an optional second hammer mill between a discharge/incline auger and an optional auxiliary auger) in a similar fashion. Likewise, during a first pass through the second level 809 of the startup sequence, a second delay timer is started, such that during subsequent passes through the level 809 (due to the counter remaining set at “2”), the second startup level 809 checks to see if the second delay timer has expired (i.e., reached a preset or user selected period of time or time limit for delay), which may be a delay of about 15 seconds, before the next component(s) are turned on. If the period or limit is not reached, then the “Increment Drum Counter” step is bypassed for return to the main loop 700. However, once the delay time period or limit is reached, the sequence for turning on the second component(s) at the second level 809 advances to increment the startup drum counter (i.e., increment the count from “2” to “3”) before returning to the main loop 700.

Each of the subsequent levels may operate much the same, including: level 811 for a third component(s) (i.e., for turning on a blower/fan) with a drum count=“3” and a third delay timer (e.g., about 3 seconds); level 813 for a fourth component(s) (i.e., for turning on an optional auxiliary conveyor and/or an optional discharge airlock that feeds into the auxiliary conveyor) with a drum count=“4” and a fourth delay timer (e.g., about 1 second); level 815 for a fifth component(s) (i.e., for turning on an incline/discharge auger and/or a cyclone airlock that feeds into the discharge auger) with a drum count=“5” and a fifth delay timer (e.g., about 1 second); level 817 for a sixth component(s) (i.e., for turning on the lower auger(s) of the auger stack) with a drum count=“6” and a sixth delay timer (e.g., about 1 second); level 819 for a seventh component(s) (i.e., for turning on the upper auger(s) of the auger stack) with a drum count=“7” and a seventh delay timer (e.g., about 1 second); and level 821 for an eighth component(s) (i.e., for turning on the product feed or extended proximal auger and/or an agitator inside the bin that feeds into the initial input opening of the auger tube(s)) with a drum count=“8”. However, the final level 821 in FIG. 8 is different than the other preceding levels of the startup sequence to account for the fact that it is at the end of the startup sequence. For example, since there may be no more component(s) to turn on after the final level 821, a timer delay at this level may be unnecessary. Instead, once the eighth component(s) are turned on at level 821 with a drum count=“8” (or higher), the startup flag may be cleared before proceeding on to the main loop 700. Since the system is now running (due to the startup sequence being completed), steps 719 and 733 of the main loop 700 described above will not direct the process to the Startup sequence 800 again unless the system is later topped or shutdown (e.g., by Stop sequence 900).

In addition to a Start sequence, a link to a Stop or Shutdown sequence was also referenced in the main loop 700 in FIG. 7A. An example embodiment of a Stop sequence 900 is shown in FIG. 9 for shutting down various components of a dryer apparatus of the present invention. Similarly to the Startup sequence 800 in FIG. 8, the Stop sequence 900 in FIG. 9 utilizes a drum counter to ensure an orderly shutdown sequence of dryer components. However, unlike the Startup sequence 800, the Stop sequence 900 may not check if an error flag is set since it would generally be preferable for the dryer to proceed with the stop or shutdown sequence if an error flag is set. In fact, the main loop 700 in FIGS. 7A and 7B may have caused the Stop sequence 900 to be initiated because an error flag is set (e.g., at step 701 in FIG. 7A). Thus, once the Stop sequence 900 is initiated, it will generally continue to completion as long as the event(s), condition(s), etc., that caused the Stop sequence 900 to be initiated continue to exist or remain in effect. Accordingly, once the Stop sequence 900 is initiated, any startup flag that may have been previously set is cleared at step 901, and a stop flag may be set at step 903. The startup and stop flags may be mutually exclusive of each other to ensure that both processes are not being initiated or executed at the same time.

After these initial steps, the actual stop sequence for the dryer components is initiated utilizing a drum counter to ensure that the dryer components are turned off in a prescribed order. Similarly to the drum counter for the startup sequence, the drum counter ensures that a first component(s) is turned off first, a second component(s) is turned off second after expiration of a first delay timer for the first component(s) has expired, a third component(s) is turned off third after expiration of a second delay timer for the second component(s), and so on until all of the components have been turned off in the desired order by the Stop sequence. For these purposes, the use of sequential identifiers including “first,” “second,” “third,” etc., in reference to a component(s), step(s), level, timer, etc., for the stop sequence are independent of the startup sequence and may generally not refer to a component, step, level, timer, etc., of the startup sequence using the same sequential identifier(s). In each case, these sequential identifiers may refer separately to the ordered sequence of levels in the respective Startup or Stop sequences.

Much like the Startup sequence 800, such an orderly Stop sequence 900 may ensure that a buildup or jamming of the product/material is unlikely to occur. Therefore, much like the Startup sequence 800, the Stop sequence 900 in FIG. 9 will be discussed as a series of levels (with each level having a plurality of steps corresponding to a particular component or set of components having a common drum count) since the internal steps for each level are generally about the same. Again, much like the Startup sequence, it is important to note that other logical orders or sequences for shutting down the dryer components are also possible that may differ from the order shown in FIG. 9. Moreover, components that are shown as being turned off or shut down together as part of a common drum count may instead be broken out into separate drum count steps. Any amounts of time for the drum counter timer(s) are examples and may also vary. Although not necessarily the case, the order for shutting down dryer components during the Stop sequence may be in an approximate reverse order as compared to the Startup sequence. Thus, upstream actuating components may be shut down first followed by the more downstream actuating components.

According to the method embodiment for a Stop sequence 900 in FIG. 9, a stop drum counter (e.g., if reset) should initially have a starting count=“1”. With a count of “1” (after having cleared any startup flag at step 901 and setting the stop flag at step 903), the stop drum counter will cause the sequence to proceed with stop level 905 for turning off the first component(s), which in this case is shown to be the product feed or extended proximal auger and agitator. Upon a first pass through the first level 905 of the stop sequence, a first delay timer is started. During subsequent passes through level 905 (due to the counter remaining set at “1”), the stop level 905 for the first component(s) checks to see if the first timer has expired (i.e., reached a preset or user selected period of time or time limit for delay), which may be a delay of about 1 second, before the next component(s) are turned off. If the period or limit is not reached, then the “Increment Drum Counter” step is bypassed for return to the main loop 700.

However, once the delay time period or limit is reached, the turn off sequence for the first component(s) at the first level 905 advances to increment the startup drum counter (i.e., increment the count from “1” to “2”) before returning to the main loop 700. Thus, on the subsequent pass through the Stop sequence 900 (assuming that the drum counter has not been reset), the actual startup sequence of components will proceed on to the next level 907 to turn off a second component(s) (e.g., the upper auger) in a similar fashion. Likewise, during a first pass through the second level 907 of the stop sequence, a second delay timer is started, such that during subsequent passes through the level 907 (due to the counter remaining set at “2”), the second stop level 907 checks to see if the second delay timer has expired (i.e., reached a preset or user selected period of time or time limit for delay), which may be a delay of about 15 seconds, before the next component(s) are turned off. If the period or limit is not reached, then the “Increment Drum Counter” step is bypassed for return to the main loop 700. However, once the delay time period or limit is reached, the sequence for turning off the second component(s) at the second level 907 advances to increment the stop drum counter (i.e., increment the count from “2” to “3”) before returning to the main loop 700, such that the Stop sequence 900 will advance to the next component(s) during the next pass. Each of the subsequent levels 909, 911, 913 for the Stop sequence 900 may occur in a similar fashion. A third level 909 may cause a third component(s) (e.g., a first hammer mill) to be turned off, a fourth level 911 may cause a fourth component(s) (e.g., a lower auger) to be turned off, and a fifth level 913 may cause a fifth component(s) (e.g., each of the remaining components) to be turned off. Although the final level 913 of the Stop sequence 900 in FIG. 9 is similar to the previous levels, it may differ in that a timer is not set since there would not be a subsequent dryer component in the sequence to be turned off. Instead, the stop flag may be cleared at step 915 and the stop drum counter may be reset at step 917 only after the final level 913 is completed. After completing steps 915, 917, the Stop sequence may then return to the top of the main loop 700 in FIG. 7A.

As mentioned above, a Stop sequence may instead turn off the components in a different logical order or sequence, and/or any combination of components sharing a common drum count number may be broken out into separate steps having different drum counts. According to some embodiments, either in the main loop (i.e., before entering a stop sequence) or after entering (and during) the stop sequence, a further step(s) may be included to determine if the system is running. In this way, the stop sequence may be avoided if the system is already turned off or shut down. For example, such a step may be included in the Stop sequence before the actual shutdown of dryer components so that the method may be diverted back to the main loop if the dryer is already turned off or shutdown.

Much of the main control loop described above in reference to FIG. 7 generally operates at a high level to determine the system mode that has been selected or set and to then cause a sequence of events to occur accordingly, including possibly turning on the hot water pump and/or initiating a startup or stop sequence in FIGS. 8 and 9 (the startup and stop sequences relating to the active components of a dryer other than the pump). The main loop may also include steps relating to safety controls (e.g., safety flags, water exit temperature, etc.) that may lead to different course(s) of action being taken during or from the main loop, including changes to modes, settings or flags, turning on/off the pump, initiating a startup or stop sequence, etc. However, the combination of the main loop with the Startup and Stop sequences in FIGS. 7-9 would only determine the right course of action depending on the system mode and certain safety controls. These processes would not operate to optimize the drying process if operating conditions remain generally within the safety and temperature limits.

According to embodiments of the present invention, a method, process and/or algorithm may be carried out, executed, implemented, etc., to optimize the process for drying a biomass or organic material by a dryer apparatus of the present invention (e.g., as long as operating conditions remain within a broader range of parameters and safety limits). Such a control method may be independent of the main loop as well as the start and stop sequences. According to many of these embodiments, a proportional-integral-derivative (PID) function may be used to automatically adjust, modulate, modify, manipulate, vary, etc., the operation of one or more component(s) of the dryer apparatus in response to changes or deviations in a measured process variable (e.g., relative to a desired target or set point for that variable). The manipulated parameter or variable (i.e., the adjusted dryer component(s)) may vary but may preferably be the fan or blower. However, other component(s) may be varied instead based on the PID function, including the feed rate, the auger speeds, etc. The measured parameter or variable may also vary but may preferably be the water exit temperature. However, other variables may conceivably be measured instead and fed or inputted into the PID function, including the air temperature and/or the level of humidity inside or exiting the auger tubes, etc.

The PID function is a combination of a proportional term, an integral term, and a derivative term that works to keep a measured process variable (e.g., a water exit temperature) at or near a set point or target value (e.g., a preset or user-selected target water temperature) by affecting a manipulated variable (e.g., a fan/blower speed). Each of the terms of the PID function inputs a measure of error (i.e., based on the departure of the process variable from the set point or target value) to affect the level or rate of operation of the manipulated variable (e.g., fan/blower speed). Each of the terms of the PID function has a separate constant that gives them relative weight, and the values for these constants may be determined empirically. The proportional (P) term is computed based on current error or deviation (e.g., difference between the water exit temperature and the target water temperature), the integral (I) term is based on the past error over a period (e.g., “area under the curve” over a period of time for water exit temperatures relative to the target water temperature), and the derivative (D) term is a measure of anticipated future error (e.g., current rate of change of the water exit temperature). A “PID” function has all three terms, whereas a “PI” function has only the P and I terms.

The process variable or PV may include any measured operational parameter that may provide a good indication about how well the material is being dried. For example, as explained above, the temperature of water exiting the machine after circulating through the jacketed sleeve(s) or space(s) surrounding the auger tube(s) may provide an indication about the extent of drying since the drop in temperature relative to the water entering the machine is a measure of how much energy was used or absorbed during the drying process, which may provide a good indication about the extent of drying for a given type and amount of material. Such an indication may be predicted, based on trial-and-error during use, or based on prior standardization or empirical evidence or data obtained from testing a particular type(s), amount(s) and/or flow rate(s) of material through the dryer apparatus having a given moisture content level(s).

Indeed, it has been found that varying the fan/blower speed according to a PID function in response to changes in the water exit temperature is effective at maintaining more optimal drying conditions. Generally speaking, increasing the fan/blower speed will lower the temperature of the material and air inside the auger tubes (by pulling or pushing off more heat), whereas decreasing the fan/blower speed will raise the temperature of the material and air inside the auger tubes (by pulling or pushing off less heat). Thus, if the measured water exit temperature decreases, then the fan/blower speed may be increased by the PID function because a greater amount of heat and energy is being absorbed by the air and material inside the auger tubes. Conversely, if the measured water exit temperature increases, then the fan/blower speed may be decreased by the PID function because a less of the heat and energy is being absorbed by the air and material inside the auger tubes. In other words, based on the water exit temperature, the fan/blower rate may be modified according to a summation of these terms, which depend on the process variable (i.e., water exit temperature readings) and the target value or set point (i.e., a target water temperature). The temperature sensor for measuring the water exit temperature (i.e., the process variable) may integrate its temperature readings, which are sent to a central control computer (see below), over a period of time. The calculation of the PID function itself by the dryer computer may also integrated over a period of time. Thus, these integrations may help to avoid rapid fluctuations in the fan/blower speed (i.e., the manipulated variable) in response to changes in the process variable due to the measurements and calculations being averaged out somewhat or a period of time. The variables of the PID including the integration time may also be chosen or selected directly or indirectly by the user or based on a preset recipe or optimized settings (perhaps depending on the type of material to be dried).

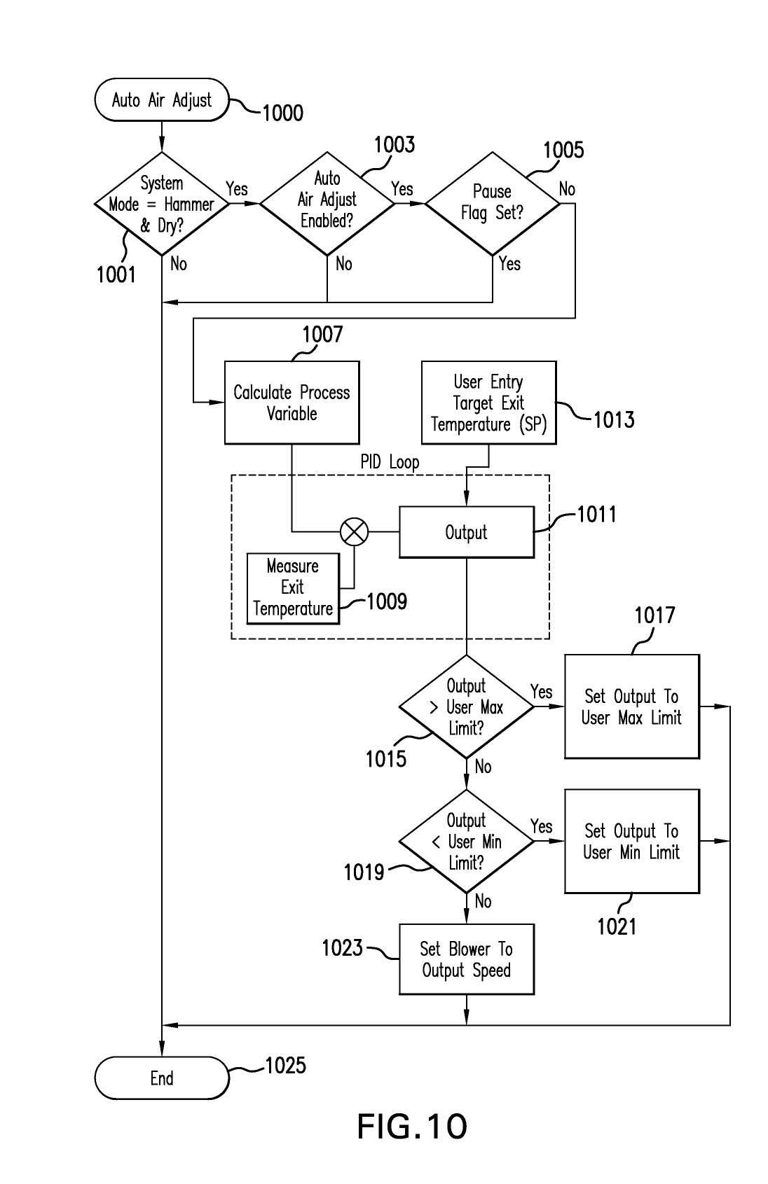

According to embodiments of the present invention, the operation of a present dryer apparatus may be optimized according to the method in FIG. 10 utilizing a PID (or PI) function. In this case, the fan or blower speed is modified according to the PID (or PI) function based on a measured water exit temperature. The “Auto Air Adjust” method 1000 in FIG. 10 may operate as a loop by returning to the top of the Auto Air Adjust method 1000 once the End 1025 of the method is reached. The Auto Air Adjust method may operate as part of, or within, another method and/or loop, such as a main loop, but may more preferably operate independently as a separate method and/or loop. The operation or operation of the Auto Air Adjust method may also depend on the system mode and whether any pause flags are set. For the method embodiment in FIG. 10, the Auto Air Adjust method 1000 may first determine if the system mode is set to “Hammer and Dry”. If the system mode is not set to Hammer and Dry, then it may proceed to End 1025. But, if the system mode is set to Hammer and Dry according to the method in FIG. 10, then it may proceed to 1003 to determine if the Auto Air Adjust setting is enabled. At 1003, if it is determined that the Auto Air Adjust is enabled, then the method may proceed to step 1005. However, if it is determined in step 1003 that the Auto Air Adjust is not enabled, then the method may proceed to End 1025. Thus, the Auto Air Adjust method in the embodiment of FIG. 10 will only proceed if the Auto Air Adjust is enabled and the system mode is set to “Hammer and Dry.” However, according to other embodiments, an Auto Air Adjust method (based on a PID or PI function) may operate under other system modes for drying a material, including possibly any Dry mode with or without a hammer mill.

Continuing with the method embodiment in FIG. 10, whether or not a pause flag is set (e.g., due to a hardware malfunction or safety issue) may be determined in step 1005. If a pause flag is set, then the method may proceed to End 1025. However, if a pause flag is not set, then the remainder of the Auto Air Adjust method may proceed by measuring and/or calculating a process variable (e.g., water exit temperature 1009) at step 1007 and then calculating a desired output value for the manipulated variable by executing a PID (or PI) function based on the measured process variable. The calculation of the manipulated variable (e.g., fan or blower speed) may be according to a PID (or PI) loop or function as described above, which may be based on a measured water exit temperature at step 1009. Based on the calculation by the PID (or PI) function, an output 1011 (e.g., an altered or adjusted fan/blower speed) may be generated, which may be an absolute value or a positive or negative differential value relative to the existing value for the manipulated variable (e.g., fan/blower speed). Such an output value may be based not only on the PID (or PI) function, but also on a preset (e.g., manufacturer hard-coded) or user-selected target water temperature, which may be entered by a user 1013 beforehand, such as via a user interface connected to a dryer computer. After the output 1011 (e.g., the adjusted fan/blower speed) is determined, the method in FIG. 10 will typically proceed to set the fan/blower speed to the output value at step 1023. However, a minimum and/or maximum fan/blower speed(s) may be preset or set by a user to make sure that the calculated output value remains within a desired range.

Thus, several intervening steps may be present after the output 1011 is determined by the PID (or PI) function but before the manipulated variable (e.g., fan/blower speed) is set to the output value. For example, as shown in FIG. 10, the Auto Air Adjust method may determine at step 1015 if the output exceeds a maximum output limit, which may be preset or selected by a user. If the output does exceed a maximum output limit, then the output (e.g., the adjusted fan/blower speed) may instead be set to the maximum output limit at step 1017 (i.e., to establish a cap for the output value) before proceeding to End 1025. However, if the output does not exceed the maximum output limit, then the method may proceed to step 1019 to determine if the output value falls below a minimum output limit, which may also be preset or selected by a user. Much like the maximum output value, if the output value falls below a minimum output limit, then the output may instead be set to the minimum output limit at step 1019 (i.e., to establish a floor for the output value) before proceeding to End 1025. However, if the output does not fall below the minimum output limit, then the method may proceed to set the manipulated variable (e.g., the fan/blower speed) to the calculated output value from the PID (or PI) function. The manipulated variable and/or the calculated output in FIG. 10 relate to the fan/blower speed and may be expressed in terms of a percentage of full capacity. The starting fan/blower speed upon or during startup may vary and may be at any level between 0% and 100%, and the PI or PID function may change the fan speed to reach a more optimal level. But, the initial speed of the fan/blower may preferably be somewhere in the middle of the range (e.g., in a range from about 25% to 75%) prior to modification based on the process variable.

As mentioned above, methods of the present invention may be implemented via hardware, software or a combination of hardware and software (including firmware, resident software, micro-code, etc.). Aspects of the present invention may be implemented by a computer according to a computer readable program code present on a computer readable medium. Indeed, some aspects of the present invention may take the form of a computer readable program product embodied in one or more computer readable media having the computer readable program code present thereon. The above-identified methods, algorithms, etc., may be performed automatically by a programmable computer, such as a microcontroller or microprocessor, that executes software residing in an accessible non-transitory computer-readable media. The computer may include a programmable logic controller (PLC) or microcontroller for receiving inputs and sending outputs to control the operation of the dryer on the basis of feedback information. The computer may further include a user interface that allows a user to enter values and operating parameters, such as various settings, fan speeds and temperatures, as discussed above.

As stated above, the computer of the present invention for controlling operation of the dryer may comprise a processor and one or more computer readable media that may be part of, in communication with, and/or utilized by the computer. The computer may comprise a programmable logic controller (PLC), a microcontroller, or other programmable data processing apparatus. The computer may also comprise one or more computers, processors, servers, etc., jointly functioning to control the operation of the dryer. The computer may be part of the dryer apparatus (e.g., housed in box, enclosure, etc.—see, e.g., 112 in FIGS. 1 and 2) and/or a separate or remote computer in communication with the dryer. The computer of the present invention may have a processor and a memory or computer readable medium that is part of, associated with, and/or accessible by the computer. Any combination of one or more computer readable media may be utilized. The computer readable media may be a computer readable signal medium or a computer readable storage medium. The computer may further have a user interface or input for a user to enter settings, values, preferences, etc.

A computer readable storage medium may be, for example, but not limited to, an electronic, magnetic, optical, electromagnetic, or semiconductor system, apparatus, or device, or any suitable combination of the foregoing. More specific examples (a non-exhaustive list) of the computer readable storage medium would include the following: a portable computer diskette, a hard disk, a random access memory (RAM), a read-only memory (ROM), an erasable programmable read-only memory (EPROM or Flash memory), an appropriate optical fiber with a repeater, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device. Program code embodied on a computer readable signal medium may be transmitted using any appropriate medium, including but not limited to wireless, wireline, optical fiber cable, RF, etc., or any suitable combination of the foregoing.

The computer may control the operation of the dryer unit by implementing instructions of a computer readable code that is stored on a computer readable medium. Computer readable program code for carrying out operations and methods of the present invention may be written in any combination of one or more programming languages, including an object oriented programming language such as Java, Scala, Smalltalk, Eiffel, JADE, Emerald, C++, CII, VB.NET, Python or the like, conventional procedural programming languages, such as the “C” programming language, Visual Basic, Fortran 2003, Peri, COBOL 2002, PHP, ABAP, dynamic programming languages such as Python, Ruby and Groovy, or other programming languages. The program code may executed on a computer that is part of the dryer apparatus and/or a remote computer or server. If used, the remote computer may be connected to the dryer through any type of network, including a local area network (LAN) or a wide area network (WAN), or the connection may be made to an external computer (for example, through the Internet using an Internet Service Provider) or in a cloud computing environment or offered as a service.

While the present invention has been disclosed with reference to certain embodiments, it will be apparent that modifications and variations are possible without departing from the spirit and scope of the invention as defined in the appended claims. Furthermore, it should be appreciated that all examples in the present disclosure, while illustrating embodiments of the invention, are provided as non-limiting examples and are, therefore, not to be taken as limiting the various aspects so illustrated. The present invention is intended to have the full scope defined by the language of the following claims, and equivalents thereof. Accordingly, the drawings and detailed description are to be regarded as illustrative and not as restrictive.

What is claimed is:

1. An apparatus for drying a material comprising:
an auger tube, the auger tube having an elongated jacket that surrounds most or all of the auger tube and encloses a jacketed space between the jacket and the auger tube;
an auger, the auger being positioned within the interior of the auger tube;
an auger motor, the auger motor being physically coupled to the auger for causing rotation of the auger; and
a blower, the blower being in fluid communication with the interior of the auger tube for causing a flow of air or gas through the auger tube by operation of the blower,
wherein the auger tube has a first end and a second end, the first end and the second end of the auger tube being on opposite longitudinal ends of the auger tube, and
wherein the auger tube has an input opening for receiving the material into the interior of the auger tube and an output opening for allowing the material to exit the interior of the auger tube, the input opening being at or near the first end of the auger tube and the output opening being at or near the second end of the auger tube.

2. The apparatus of claim 1, wherein the auger tube has a circular cross-sectional shape.

3. The apparatus of claim 2, wherein the cross-sectional diameter of the auger tube is within a range from about 10 inches to about 30 inches.

4. The apparatus of claim 1, wherein the auger tube has a length within a range from about 15 feet to about 45 feet.

5. The apparatus of claim 1, wherein the length of the auger is about the same as the length of the auger tube.

6. The apparatus of claim 1, wherein the diameter of the fighting of the auger is about ¼ inch to about 4 inches less than the diameter of the auger tube.

7. The apparatus of claim 1, wherein the blower is positioned at or near the second end of the auger tube.

8. The apparatus of claim 1, wherein the auger tube comprises two or more auger tube segments assembled together.

9. An apparatus for drying a material comprising:
two or more auger tubes comprising a first auger tube and a second auger tube;
two or more augers comprising a first auger and a second auger, the first auger being positioned within the interior of the first auger tube and the second auger being positioned within the interior of the second auger tube;
at least one auger motor, the at least one auger motor comprising a first auger motor physically coupled to one or both of the first and second augers for causing rotation of one or both of the first and second augers; and
a blower, the blower being in fluid communication with the interiors of the two or more auger tubes for causing a flow of air or gas through the two or more auger tubes,
wherein a first jacket surrounds most or all of the first auger tube and encloses a first jacketed space between the first jacket and the first auger tube, and wherein a second jacket surrounds most or all of the second auger tube and encloses a second jacketed space between the second jacket and the second auger tube, and
wherein each of the two or more auger tubes has a first end and a second end, the first end and the second end of each auger tube being on opposite longitudinal ends of the auger tube,
wherein each of the two or more auger tubes has an input opening for receiving the material into the interior of the auger tube and an output opening for allowing the material to exit the interior of the auger tube, the input opening being at or near a first end of the respective auger tube and the output opening being at or near a second end of the respective auger tube, and
wherein the first and second auger tubes are arranged in series such that the material exiting the output opening of the first auger tube is received into the second auger tube through the input opening of the second auger tube.

10. The apparatus of claim 9, wherein the at least one auger motor comprises a first auger motor and a second auger motor, the first auger motor being physically coupled to the first auger and the second auger motor being physically coupled to the second auger.

11. The apparatus of claim 9, wherein the output opening of the first auger tube is positioned above the input opening of the second auger tube.

12. The apparatus of claim 9, wherein the first and second auger tubes are stacked, such that the first auger tube is positioned above and in parallel to the second auger tube, such that the proximal first end of the first auger tube is positioned above the proximal second end of the second auger tube, and the distal second end of the first auger tube is positioned above the distal first end of the second auger tube.

13. The apparatus of claim 9, wherein the input opening of the first auger tube is the initial input opening of the two or more auger tubes.

14. The apparatus of claim 9, further comprising:
an extended proximal tube, wherein the extended proximal tube is aligned and continuous with the first auger tube, such that the input opening of the first auger tube is continuous with the interior of the extended proximal tube.

15. The apparatus of claim 14, wherein the material enters the extended proximal tube through an initial input opening of the extended proximal tube.

16. The apparatus of claim 15, wherein the material is received into the extended proximal tube from a hopper or bin positioned above the initial input opening of the extended proximal tube.

17. The apparatus of claim 14, further comprising:
an extended proximal auger; and
a proximal auger motor,
wherein the extended proximal auger is positioned within the interior of the extended proximal tube, and
wherein the proximal auger motor is physically coupled to the extended proximal auger for causing rotation of the extended proximal auger.

18. The apparatus of claim 9, wherein the first auger tube comprises a main portion and an extended proximal portion, the extended proximal portion of the first auger tube being aligned and continuous with the main portion of the first auger tube.

19. The apparatus of claim 18, further comprising:
an extended proximal auger; and
a proximal auger motor,
wherein the extended proximal auger is positioned within the interior of the extended proximal portion of the first tube, and
wherein the proximal auger motor is physically coupled to the extended proximal auger for causing rotation of the extended proximal auger.

20. The apparatus of claim 18, wherein the material enters the extended proximal portion of the first auger tube through an initial input opening of the extended proximal portion.

21. The apparatus of claim 20, wherein the material is received into the extended proximal portion of the first auger tube from a hopper or bin positioned above the initial input opening of the extended proximal portion.

22. The apparatus of claim 9, wherein the blower is positioned at or near a final output opening of the two or more auger tubes.

23. The apparatus of claim 9, wherein each of the first and second jackets have a first port for receiving a hot liquid into the respective jacketed space and a second port for allowing the hot liquid to exit the respective jacketed space.

24. The apparatus of claim 9, further comprising:
a hammer mill, the hammer mill having an enclosed space with an input opening and an output opening, a plurality of radially arranged hammers, a hammer mill motor, and a screen,
wherein the hammer mill motor is physically coupled to the plurality of radially arranged hammers for causing rotation of the radially arranged hammers,
wherein the screen is positioned between the plurality of radially arranged hammers and the output opening of the hammer mill, and
wherein the hammer mill is positioned and configured to receive the material exiting the output opening of the first auger tube through the input opening of the hammer mill and to allow the material to exit the output opening of the hammer mill and enter the second auger tube through the input opening of the second auger tube.

25. The apparatus of claim 9, further comprising:
a hammer mill, the hammer mill having an enclosed space with an input opening and an output opening, a plurality of radially arranged hammers, a hammer mill motor, and a screen,
wherein the hammer mill motor is physically coupled to the plurality of radially arranged hammers for causing rotation of the radially arranged hammers,
wherein the screen is positioned between the plurality of radially arranged hammers and the output opening of the hammer mill, and
wherein the hammer mill is positioned at or near the distal end of the stack to receive the material exiting the output opening of the first auger tube through the input opening of the hammer mill and to allow the material to exit the output opening of the hammer mill and enter the second auger tube through the input opening of the second auger tube.

26. The apparatus of claim 9, further comprising:
a discharge auger, the discharge auger configured to receive the material from a final output opening of the two or more augers.

27. The apparatus of claim 26, further comprising an airlock system, the air lock system comprising a cyclone, the cyclone being configured to receive air or gas from the blower and cause particles in the air or gas to settle out before the air or gas exits the cyclone.

28. The apparatus of claim 27, wherein the air lock system further comprises an air lock that receives the particles from the cyclone and directs the particles into the discharge auger.

29. A method for drying a material comprising the following steps:
(a) introducing the material into an auger tube at via an input opening, the auger tube having a first end and a second end, the first end and the second end being at opposite ends of the auger tube along the longitudinal axis of the auger tube, wherein the input opening is at or near the first end of the auger tube;
(b) moving the material longitudinally through the interior of the auger tube toward the second end of the auger tube by rotation of an auger present inside the interior of the auger tube, the rotation of the auger being driven by an auger motor physically coupled to the auger;
(c) heating the auger tube by a liquid or water having an elevated temperature present within a jacketed space enclosed by a jacket surrounding most or all of the auger tube; and
(d) causing air or gas to flow longitudinally through the interior of the auger tube by a blower in fluid communication with the interior of the auger tube.

30. The method of claim 29, further comprising:
(e) allowing the material to exit the auger tube through an output opening at or near the second end of the auger tube.

31. The method of claim 29, wherein step (a) comprises introducing the material into an extended proximal portion of the auger tube through the initial input opening.

32. The method of claim 29, wherein step (a) comprises introducing the material into an extended proximal tube through the initial input opening, the interior of the extended proximal tube being continuous with the interior of the auger tube.

33. The method of claim 29, wherein the heating step (c) further comprises:
(f) inputting a liquid or water at a first elevated temperature into the jacketed space through a first port of the jacket, and
(g) outputting the liquid or water at a second elevated temperature from the jacketed space through a second port of the jacket.

34. The method of claim 33, further comprising:
(h) measuring an exit temperature of the liquid or water at or near where the liquid or water exits the jacketed space; and
(i) adjusting the speed of operation of the blower based on the exit temperature.

35. A method for drying a material comprising the following steps:
(a) introducing the material into a first auger tube in a series of two or more auger tubes of a dryer apparatus via a first input opening, the first auger tube having a first end and a second end, the first end and the second end being at opposite ends of the first auger tube along the longitudinal axis of the first auger tube,
wherein the input opening being at or near the first end of the first auger tube;
(b) moving the material longitudinally through the interior of the first auger tube by rotation of a first auger present within the interior of the first auger tube, the rotation of the first auger being driven by a first auger motor physically coupled to the first auger;
(c) introducing the material into a second auger tube in the series of two or more auger tubes of the dryer apparatus via a first output opening of the first auger tube and a second input opening of the second auger tube, the second auger tube having a first end and a second end, the first end and the second end being at opposite ends of the second auger tube along the longitudinal axis of the second auger tube,
wherein the first output opening is at or near the second end of the first auger tube, and the second input opening is at or near the first end of the second auger tube;
(d) moving the material longitudinally through the interior of the second auger tube by rotation of a second auger present within the interior of the second auger tube, the rotation of the second auger being driven by a second auger motor physically coupled to the second auger;
(e) heating the first and second auger tubes by a liquid or water having a first elevated temperature inside a first jacketed space enclosed by a first jacket surrounding most or all of the first auger tube and by the liquid or water having a second elevated temperature inside a second jacketed space enclosed by a second jacket surrounding most or all of the second auger tube; and
(f) causing air or gas to flow through the interior of each of the first and second auger tubes by a blower in fluid communication with the interior of the first and second auger tubes.

36. The method of claim 35, further comprising:
(g) allowing the material to exit the series of two or more auger tubes through an output opening at or near the second end of the second auger tube.

37. The method of claim 35, wherein step (a) comprises introducing the material into an extended proximal portion of the first auger tube through an initial input opening.

38. The method of claim 35, wherein step (a) comprises introducing the material into an extended proximal tube through an initial input opening, the interior of the extended proximal tube being continuous with the interior of the first auger tube.

39. The method of claim 35, further comprising:
(k) breaking up the material by passing the material through a hammer mill positioned in series between the first auger tube and the second auger tube.

40. The method of claim 35, wherein the heating step (e) further comprises:
(h) inputting a liquid or water at a first elevated temperature into the first jacketed space through a first port of the first jacket;
(i) circulating the liquid or water from a second port of the first jacket to a first port of the second jacket and into the second jacketed space; and
(j) outputting the liquid or water at a second elevated temperature from the second jacketed space through a second port of the second jacket.

41. The method of claim 40, wherein the liquid or water is water, and wherein the first elevated temperature is in a range from about 185° F. to about 210° F.

42. The method of claim 40, wherein the liquid or water comprises oil, and wherein the first elevated temperature is in a range from about 200° F. to about 400° F.

43. The method of claim 40, wherein the second elevated temperature is less than the first elevated temperature.

44. The method of claim 40, further comprising:
(k) monitoring by a computer an exit temperature of the liquid or water measured by a temperature sensor at or near where the liquid or water exits the second jacketed space; and
(l) adjusting by the computer the flow rate of the air or gas through the first and second auger tubes based on the monitored exit temperature by changing the speed of operation of the blower to an adjusted speed.

45. The method of claim 44, further comprising:
(m) determining by the computer the adjusted speed of the blower based on a proportional-integral-derivative (PID) function based on a target temperature or the liquid or water and the monitored exit temperature.

46. The method of claim 45, wherein the target temperature is in a range from about 185° F. to about 205° F.

47. The method of claim 35, further comprising:
(n) shutting down one or more components of the dryer apparatus if the measured exit temperature is below a predetermined shutdown temperature.

48. The method of claim 35, further comprising:
(o) adding one or more additives to the material, wherein the one or more additives are added to the material prior to step (c) of introducing the material into the second auger tube.

49. The method of claim of 48, wherein the one or more additives comprise glycerine.

50. A composition comprising a material produced by the following steps:
(a) adding one or more additives to the material;
(b) moving the material longitudinally through each of the one or more auger tubes of a dryer apparatus by rotation of a respective auger inside the auger tube, the rotation of the respective auger being driven by a respective auger motor physically coupled to the auger;
(c) heating the one or more auger tubes by a liquid or water having an elevated temperature when inputted into a jacketed space enclosed by a jacket surrounding one of the auger tubes; and
(d) causing air or gas to flow through the interior of each of the one or more auger tubes by a blower in fluid communication with the interior of each of the auger tubes.

51. The composition of claim 50, wherein the one or more additives comprises glycerine.
